(19) United States
(12) Patent Application Publication
(10) Pub. No.: US 2024/0428650 A1
(43) Pub. Date: Dec. 26, 2024

(54) MACHINE LEARNING-BASED WIN PROBABILITIES IN WAGERING GAMES

(71) Applicant: Primero Games, LLC, Norcross, GA (US)

(72) Inventor: Michael Mayo Macke, Duluth, GA (US)

(21) Appl. No.: 18/340,616

(22) Filed: Jun. 23, 2023

(51) Int. Cl. G07F 17/32; G07F 17/34

(52) U.S. Cl. CPC G07F 17/323; G07F 17/34

(57) ABSTRACT

A computing device can determine gaming data including outcomes for a historical wagering games associated with a particular user account. The computing device can determine a skill score corresponding to the particular user account based on the gaming data. The computing device can render a reel including a subset of indicia on a display device. The computing device can modify an attribute of the wagering game based on the skill score. The computing device can rotate the reel on the display device. The computing device can receive an input from a user. The computing device can stop rotation of the reel at a particular position based on the input and a current value of the attribute. The computing device can determine an outcome of a wagering game based on a stopped position of the reel.

### TECHNICAL FIELD

The present systems and methods relate generally to configuring wagering games and award mechanisms based on artificial intelligence (AI) analyses of patron performance.

### BACKGROUND

Previous solutions to facilitating payout events on gaming devices, and the like, fail to provide systems and processes for adjusting attributes of wagering games based on patron performance. For example, in previous solutions, the configuration of difficulty settings is completely agnostic as to performance of a patron during wagering games. As such, the gaming device may present an intolerable level of difficulty to an unskilled first patron and an insufficient level of difficulty to a more skillful second patron. Accordingly, there exists a long-felt, but unresolved need for systems and processes that can evaluate patron performance and adjust wagering game attributes based thereon.

### SUMMARY OF THE DISCLOSURE

The present systems and methods relate generally to analyzing patron performance in a gaming environment and adjusting one or more attributes of a wagering game based thereon. Briefly described, and according to one embodiment, aspects of the present disclosure relate generally to systems and processes for determining or predicting patron skill, and for configuring wagering game experiences based on patron skill.

In at least one embodiment, as described herein, a “wagering game” can refer to any game in which one or more user inputs may influence an outcome of the game. For example, a wagering game can include a skill stop game in which a patron attempts to stop a plurality of rotating reels at particular positions such that a subset of a plurality of indicia on the reels are in alignment (e.g., respective to a visual indicator). In another example, a wagering game can include a skill stop game in which, over a suitable number of repetitions, a patron attempts to stop a shape with changing indicia such that the indicia shown on the shape at each point of stoppage comprise a particular indicia sequence.

In one or more embodiments, the present system estimates patron skill in one or more wagering games based on processing gaming data. The system can process the historical gaming data via one or more machine learning models, techniques, algorithms, or combinations thereof. The system can generate, via the machine learning model, a prediction of patron skill, such as in the form of a skill score, skill level classification, or combination thereof. The system can generate predictions of how a patron may perform in a wagering game when one or more attributes of the wagering game are configured to a particular state or setting. The system can configure a wagering game to present increased difficulty to a skilled patron or reduced difficulty to a lesser skilled patron. The optimization of wagering game experiences may provide particular advantages including, but not limited to, normalization of gaming experiences across various skill levels, maintaining patron engagement and interest in game participation, and stabilization of wagering game outcomes and awards provided therefore.

As used herein, “gaming data” can include any data associated with a wagering game or a patron's engagement with a wagering game. Non-limiting examples of gaming data include user inputs, wagering game attributes, wagering game outcomes, and wagering game awards. As used herein, “wagering game attributes” can include any property of a wagering game, a gaming device that carries out the wagering game, or a gaming environment in which the gaming device or wagering game occurs. Non-limiting examples of wagering game attributes include indicia shown during the wagering game, properties of indicia (e.g., dimensions, color, pattern, indicia similarity, etc.), wagering game speed (e.g., reel speed, indicia movement speed, indicia replacement speed, etc.), hitbox properties (e.g., dimensions, availability, etc.), and input device settings (e.g., type, latency, requisite input composition, etc.).

In an exemplary scenario, the system receives, via a gaming device, request to initiate a wagering game, the request including a patron identifier. The requested wagering game is a skill stop game in which a patron attempts to stop a plurality of rotating reels at particular positions such that a subset of a plurality of indicia on the reels are positioned in alignment. The system retrieves a user account based on the patron identifier. The system determines a subset of stored gaming data corresponding to the user account. The system processes the subset of gaming data via one or more machine learning models to generate a skill score for the user account. Based on the skill score, the system determines that a patron corresponding to the patron identifier is of a high skill level for the requested wagering game type. In response to the determination, the system modifies one or more attributes of the wagering game, such as increasing a rotation speed of reels to increase the difficulty of the wagering game commensurate to the determined skill of the patron.

Continuing this scenario, the system initiates and resolves a plurality of wagering games on behalf of the user account, thereby generating additional gaming data. The system receives, via the same or a different gaming device, a second request to initiate a wagering game. The system processes the aforementioned subset of gaming data and the additional gaming data via the machine learning model to generate a second skill score for the user account (e.g., in addition to or replacing the aforementioned skill score). Based on the second skill score, the system determines that the patron corresponding is of a lower skill level for the requested wagering game type. In response to the determination, system modifies one or more attributes of the wagering game, such as decreasing reel speed or increasing hitbox dimension(s) for particular indicia to decrease the difficulty of the wagering game commensurate to the updated skill of the patron.

### BRIEF SUMMARY OF THE DRAWINGS

For a more complete understanding of the embodiments and the advantages thereof, reference is now made to the following description, in conjunction with the accompanying figures briefly described as follows:

FIG. 1 shows an exemplary gaming environment in which the present gaming system may operate, according to one embodiment of the present disclosure;

FIG. 2 shows an exemplary network environment in which the present gaming system may operate, according to one embodiment of the present disclosure;

FIG. 3 shows an exemplary skill determination process, according to one embodiment of the present disclosure;

FIG. 4 shows an exemplary gaming process, according to one embodiment of the present disclosure;

FIG. 5 shows an exemplary model generation process, according to one embodiment of the present disclosure;

FIG. 6 shows an exemplary gaming device, according to one embodiment of the present disclosure;

FIG. 7 shows an exemplary reel schema, according to one embodiment of the present disclosure;

FIG. 8 shows an exemplary reel schema, according to one embodiment of the present disclosure;

FIG. 9 shows an exemplary reel schema, according to one embodiment of the present disclosure; and

FIG. 10 shows a schematic block diagram that illustrates an example computing environment employed in the network environment of FIG. 2 according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DESCRIPTION OF THE DRAWINGS

In the following paragraphs, the embodiments are described in further detail by way of example with reference to the attached drawings. In the description, well-known components, methods, and/or processing techniques are omitted or briefly described so as not to obscure the embodiments. As used herein, the “present disclosure” refers to any one of the embodiments described herein and any equivalents. Furthermore, reference to various feature(s) of the “present embodiment” is not to suggest that all embodiments must include the referenced feature(s).

Among embodiments, some aspects of the present disclosure are implemented by a computer program executed by one or more processors, as described and illustrated. As would be apparent to one having ordinary skill in the art, one or more embodiments may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above. As used herein, the term “stated” is meant to indicate that a value, indicia, or other data is viewable and/or accessible to a patron. As used herein, the term “unstated” is meant to indicate that a value, indicia, or other data is not viewable and/or accessible to a patron. As used herein, “difficulty” may refer to a probability of obtaining one or more outcomes in a wagering game. For example, a lower difficulty may refer to an increased probability of obtaining a particular outcome (e.g., as compared to an average difficulty). As another example, a greater difficulty may refer to a decreased probability of obtaining a particular outcome. As used herein, a pseudo-random seed can include any number (or vector) used to initialize a pseudo-random number generator. A pseudo-random value can include any output of a pseudo-random number generator. In some embodiments, a pseudo-random value can be one that is statistically random but derived from a known starting point. In other embodiments, a pseudo-random value can be one that is statistically random and generated according to a random number generating algorithm by a computer.

For descriptive purposes, various gaming system functions are described as being performed by particular gaming elements; however, no limitation of function of gaming elements is intended, and functions performed by one element of a gaming system may be performed by other elements of the gaming system, as would be appreciated and understood by one of general skill in the art.

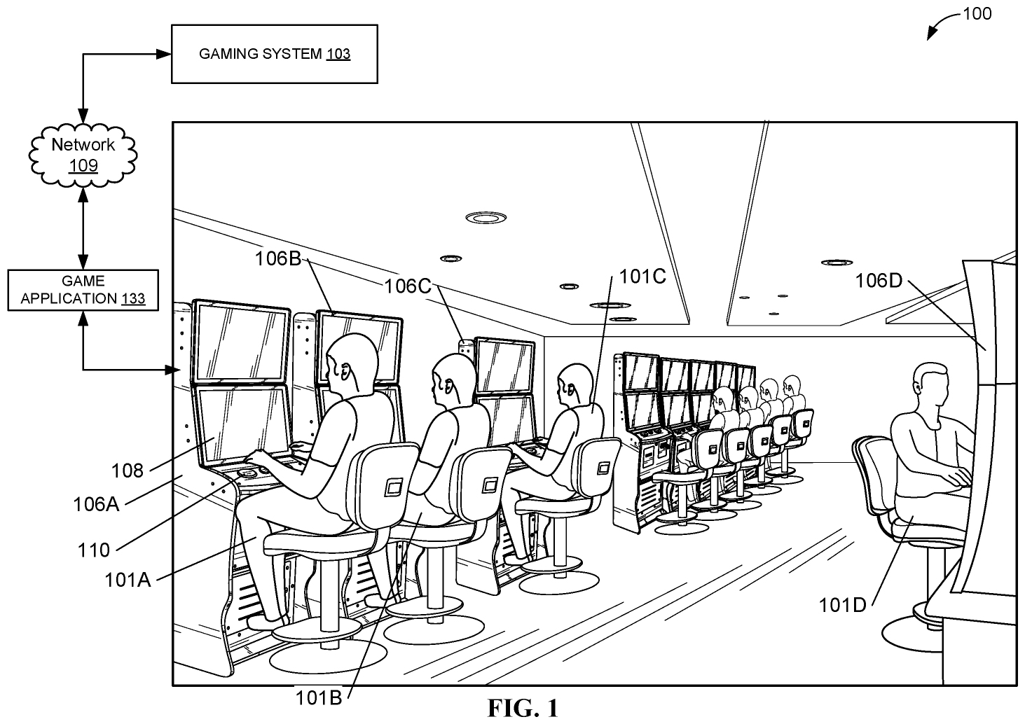

Referring now to the figures, for the purposes of example and explanation of the fundamental processes and components of the disclosed systems and processes, reference is made to FIG. 1, which illustrates an exemplary gaming area 100 according to one embodiment of the present disclosure. As will be understood and appreciated, the exemplary gaming area 100 shown in FIG. 1 represents merely one approach or embodiment of the present system, and other aspects are used according to various embodiments of the present system.

An exemplary gaming area 100 can include, for example, one or more casino floors. The gaming area 100 can include a plurality of gaming devices 106A-D in communication with a gaming system 103 via a network 109. Each gaming device 106A-D can include a game application 133 configured to execute wagering games, such as, for example, skill stop games (e.g., electronic reel slot machines, digital reel slot displays, etc.). The wagering game can be any game that allows a patron to provide an input that may influence an outcome of the game. For example, a skill stop game can include a plurality of reels that each include a plurality of indicia. To play the wagering game, the game application 133 can render a plurality of reels on a display device 108 of the corresponding gaming device 106A-D. The game application 133 can continuously rotate the plurality of reels on the display device 108. The game application 133 can receive, via an input device 110, one or more user inputs. The game application 133 can stop the rotation of the plurality of reels based on the one or more user inputs. The game application 133 can determine an outcome of the wagering game on the stopped position of each reel (e.g., or indicia thereof). The user input includes, for example, pressing a button or providing an input to a region of a touchscreen display device. The game application 133 can provide an award based on the outcome of wagering game.

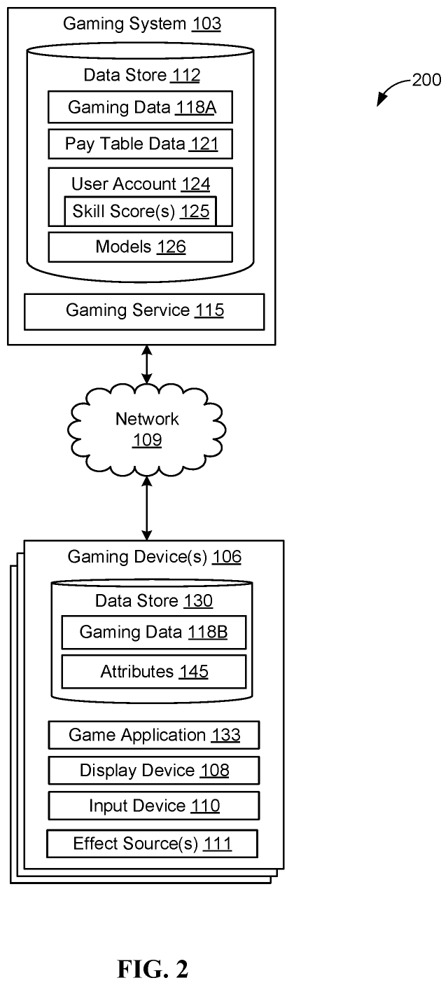

The game application 133 of each gaming device 106A-D can communicate with a gaming system 103 via one or more networks 109 (see also FIG. 2 and accompanying description herein). As further shown in the figures and described herein, the game system 103 can determine a skill score corresponding to the patron 101A-D, or a user account associated therewith. The game system 103 can cause the game application 133 to modify one or more attributes of a wagering game based on the skill score.

In an exemplary scenario, the gaming system 103 generates a first skill score for the patron 101A. Based on the first skill score (e.g., or a comparison thereof to one or more thresholds), the game application 133 increases a reel rotation speed for a wagering game initiated at the gaming device 106A. The gaming system 103 generates a second skill score, lower than the first skill score, for the patron 101B. Based on the second skill score, or comparison thereof to the predetermined threshold(s), the game application 133 maintains a default reel rotation speed for a wagering game initiated at the gaming device 106B. The gaming system 103 generates a third skill score, lower than the second skill score. Based on the third skill score, or a comparison thereof to the predetermined threshold(s), the game application reduces a reel rotation speed for a wagering game initiated at the gaming device 106C. In some embodiments, various functionality described herein as being performed by the gaming service 103 can also be performed by the gaming device 106. As an example, the skill scores may be generated by the gaming device 106, such as, for example, by the game application 133.

In another exemplary scenario, the patron 101A and patron 101D are the same patron at respective first and second time periods, the second time period being subsequent to the first time period. While playing one or more wagering games at the gaming device 106A during the first time period, the gaming system 103 determines a first skill score for the patron 101A based on a first set of gaming data. Based on the first skill score, the game application 133 of the gaming device 106A configures a hitbox of wagering games at the gaming device 106A to a first size. The gaming system 103, via the game application 133, receives and stores an additional set of gaming data based on the wagering games initiated on behalf of the patron 101A at the gaming device 106A. While playing one or more wagering games at the gaming device 106D, the gaming system 103 determines skill score for the patron 101D based on the first set of gaming data and the additional set of gaming data. Based on the second skill score, a game application 133 of the gaming device 106D configures a hitbox of wagering games at the gaming device 106D to a second size that is greater than the aforementioned first size, thereby reducing the difficulty of wagering games played by the patron 101D at the gaming device 106D compared to a difficulty of the wagering games played by the patron 101A at the gaming device 106A.

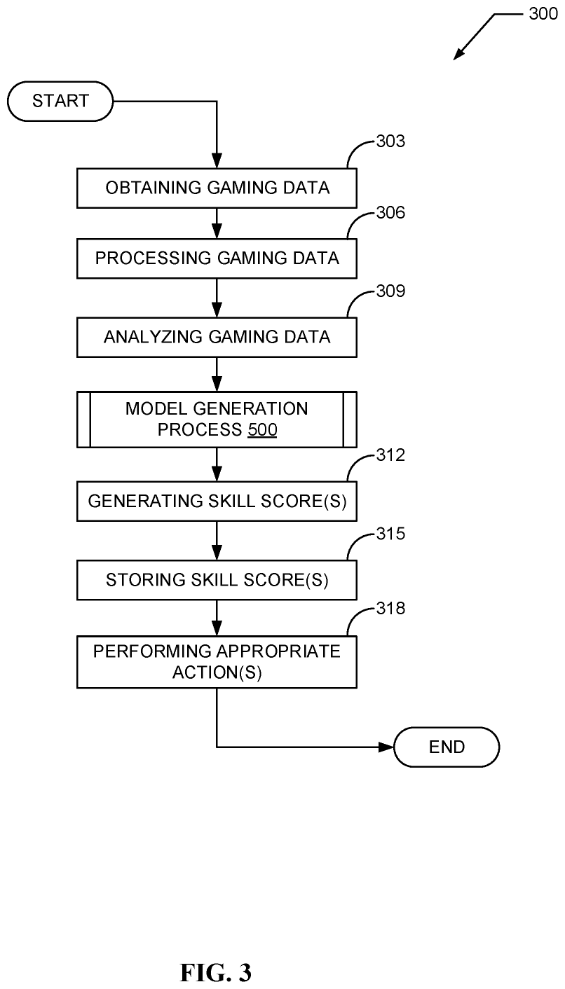

To initiate wagering games, the gaming devices 106A-D can receive selections from patrons 101A-D at input devices 110. Each gaming device 106A-D includes one or more display devices 108 on which the gaming device renders various information, such as outcomes of wagering games, victory criteria (e.g., combinations of indicia), prizes, and values of coin-in. The gaming system 103 can track the play of each patron 101A-D, for example, by assigning each patron 101A-D a unique identifier that is associated with each wagering game, pay-in event, and payout event initiated by the corresponding patron. Each gaming device 106A-D includes a game application 133. The game application 133 can perform various actions and processes to initiate and resolve wagering games. The game system 103 or game application 133 can perform processes described herein, such as, for example, as skill determination process 300, gaming process 400, or model generation process 500 shown in FIGS. 3, 4, and 5, respectively, and described herein. It will be understood and appreciated that actions and processes described as being performed by the gaming system 103 may instead be performed by the game application 133, and vice versa.

The gaming system 103 can record various metrics related to activities of the patrons 101A-D, including, but not limited to, total coin-in, total credits, total winnings, and gaming data. The gaming data can include any information related to a patron's engagement with gaming devices or wagering games, such as, for example, patrons inputs, metadata of inputs (e.g., timestamp, frequency, input device 110 used, location of input, etc.), wagering game outcomes, wagering game awards or prizes won, wagering games awards or prizes nearly won (e.g., near-win indicia combinations or other near-victory events), wagering pattern, and estimates or predictions of patron skill (e.g., skill scores, skill level categorizations, etc.). Further exemplary gaming data are discussed in the foregoing description of FIG. 2 and gaming data 118A, 118B.

In response to a patron initiating a wagering game at a gaming device 106, the gaming system 103 can determine a user account corresponding to the patron. For example, in response to receiving input including a patron identifier, the gaming system 103 can determine a user account based on the patron identifier. The gaming system 103 can transmit the user account, or data thereof, to the gaming device 106. The gaming system 103 can determine a skill score based on the user account. The gaming system 103 can transmit the skill score to the gaming device 106. The gaming system 103 can determine historical gaming data corresponding to the user account. The gaming system 103 can process the historical gaming data to generate the skill score. The gaming system 103 can receive, from the gaming device 106, an indication of a particular wagering game to be initiated. The gaming system 103 can process the historical gaming data based on the particular wagering game to generate the skill score. In some embodiments, the gaming system 103 transmits the historical gaming data to the gaming device 106 for processing (e.g., the gaming device 106 can generate the skill score). The gaming system 103 can determine an association between the user account and one of a plurality of skill levels. The gaming system 103 can transmit the skill level to the gaming device 106.

The gaming system 103 and/or gaming device 106 can configure one or more attributes of the wagering game based on one or more factors. The one or more factors can include, but are not limited to, the user account, historical gaming data corresponding to the user account, current gaming data corresponding to the user account, skill score(s), skill level(s), inputs from the patron and/or other patrons, outcome of one or more wagering games, and winnings of the patron and/or other patrons. The one or more attributes of the wagering game can include, but are not limited to, reel speed(s), reel rotation direction(s), reel acceleration, indicia rendered on a reel, hitbox attributes (e.g., dimension(s), availability, distribution, etc.), input device settings (e.g., latency, mapping of input device to one or more reels, input requirements for controlling reels, etc.), and effect source settings (e.g., (de) activation, intensity, frequency, duration, etc.). In one example, in response to determining a skill score meets a first predetermined threshold, the gaming device 106 increases the rotation speed of one or more reels (e.g., thereby increasing difficulty of the wagering game). In another example, in response to determining a skill score meets a second predetermined threshold, the gaming device 106 increases one or more dimensions of a hitbox for an indicium (e.g., thereby reducing difficulty of the wagering game).

The gaming system 103 can initialize a skill score to a predetermined value. In some embodiments, the game application 133 performs skill score initialization and/or configuration operations. The gaming system 103 can process historical gaming data corresponding to a plurality of user accounts to generate an average skill score value. The gaming system 103 can initialize a skill score to the average skill score value. The gaming system 103 can process historical gaming data to identify a subset of the historical gaming data corresponding to a predetermined win rate. The gaming system 103 can determine an average skill score value based on the subset of the historical gaming data. The gaming system 103 can initialize a skill score of a user account in response to creation of the user account. For example, in response to generating a user account on behalf of a patron, the gaming system 103 initializes the skill score of the user account to an average skill score value. The gaming system 103 can store the skill score in association with the user account at the data store 112.

The gaming devices 106A-D can print a ticket that encodes a patron identifier and a skill score corresponding to the user account with which the patron identifier is associated. At a later time point a second gaming device 106 can receive the printed ticket and coin-in from the patron and initiate a wagering game, thereby causing the gaming system 103, or game application 133 of the second gaming device 106, to configure one or more properties of the wagering game based on the skill score. Following completion of the wagering game, the gaming system 103 or game application 133 can update the skill score based on the outcome of the wagering game and/or other gaming data related to the wagering game.

In some embodiments, based on respective values of skill score, the gaming system 103 can assign each patron 101A-D to a skill level. Alternatively, the gaming system 103 can assign each gaming device 106A-D to a skill level based on the skill score of the respective user account corresponding to the patron 101A-D.

In an exemplary scenario, the gaming system 103 determines that patrons 101A-D have skill scores 40/100, 55/100, 61/100, and 75/100, respectively. In the same example, the gaming system 103 assigns wagering games of patron 101A to a first skill level, wagering games of patrons 101B, 101C to a second skill level, and wagering games of patron 101D to a third skill level. The gaming system 103 can adjust one or more attributes of each wagering game based on the assigned skill level. For wagering games assigned to the first skill level, the gaming system 103 configures hitbox dimensions of one or more indicia thereof to a first set of values. For wagering games assigned to the second skill level, the gaming system 103 configures hitbox dimensions of one or more indicia thereof to a second set of values that are less than the first set of values (e.g., thereby increasing wagering game play difficulty). For wagering games assigned to the third skill level, the gaming system 103 configures hitbox dimensions of one or more indicia thereof to a third set of values that are less than the second set of values (e.g., thereby further increasing wagering game play difficulty).

FIG. 2 shows an exemplary network environment 200 in which the gaming system 103 and one or more gaming devices 106 may operate. The gaming system 103 is in data communication with the gaming device 106 via one or more networks 109. The network 109 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks. The gaming device 106 can be a physical gaming device or an online gaming device. For example, in an online embodiment, the gaming device 106 can include games (wagering or not) hosted on one or more online pages. The gaming device 106 can include a portal for playing virtual wagering games. The gaming device 106 can transmit data regarding patron and/or user behavior (e.g., wagering game performance, winnings, digital currency, etc.) to the gaming system 103.

The gaming system 103 can include, for example, a point of sale “POS” system, a server computer, or any other system providing computing capability. Alternatively, the gaming system 103 may employ computing devices that may be arranged, for example, in one or more server banks or computer banks or other arrangements. Such computing devices can be located in a single installation or may be distributed among many different geographical locations. For example, the gaming system 103 can include computing devices that together may include a hosted computing resource, a grid computing resource, and/or any other distributed computing arrangement. In some cases, the gaming system 103 can correspond to an elastic computing resource where the allotted capacity of processing, network, storage, or other computing-related resources may vary over time.

Various applications and/or other functionality may be executed in the gaming system 103 according to various embodiments. Also, various data is stored in a data store 112 that is accessible to the gaming system 103. The data store 112 can be representative of a plurality of data stores 112 as can be appreciated. The data stored in the data store 112, for example, is associated with the operation of the various applications and/or functional entities described below.

The components executed on the gaming system 103, for example, include a gaming service 115, and other applications, services, processes, systems, engines, or functionality not discussed in detail herein. Functions and operations described herein as being performed by the gaming system 103 may be performed by the gaming service 115. The gaming service 115 can be executed to monitor game play on the one or more gaming devices 106 and facilitate additional features on the gaming devices 106. The gaming service 115 can perform processes described herein, such as the skill determination process 300, gaming process 400, or model generation process 500 shown in FIGS. 3, 4, and 5, respectively, and described herein. The gaming service 115 may be representative of a plurality of services, modules, or programs. The gaming service 115 may include, or communicate with, one or more external services or systems configured to perform one or more functions described herein.

The gaming service 115 can determine a subset of gaming data 118A corresponding to a user account 124 and generate a skill score of the user account 124 by processing the subset via one or more models 126 and/or other suitable techniques. The gaming service 115 can transmit the skill score to the gaming device 106 (e.g., to effect one or more changes to attributes 145 of a wagering game initiated thereon). The gaming service 115 can process gaming data 118A via one or more models 126 to predict an effect of a change to an attribute 145 on an outcome of a wagering game. For example, the gaming service 115 can predict whether a modification to an attribute 145 is likely to increase, decrease, or maintain the probability of achieving a particular outcome in a wagering game. The gaming service 115 can determine one or modifications to one or more attributes 145 based on a skill score 125. The gaming service 115 can transmit attribute modifications to the game application 133, thereby causing the game application 133 to initiate the attribute modifications on the corresponding gaming device 106.

The data stored in the data store 112 includes, for example, gaming data 118A, pay table data 121, user accounts 124, models 126, and potentially other data. The gaming data 118A may include any gaming data 118B from gaming devices 106 (e.g., the gaming data 118A may be an aggregation of all gaming data 118B from all gaming devices 106). The gaming service 115 can receive gaming data 118B from the gaming device 106 and update the gaming data 118A to include the gaming data 118 and/or data derived therefrom.

The gaming data 118A can include any information related to a patron's engagement with gaming devices or wagering games, such as, for example, patrons inputs, metadata of inputs (e.g., timestamp, frequency, input device 110 used, location of input, etc.), wagering game outcomes, wagering game awards or prizes won, wagering games awards or prizes nearly won (e.g., near-win indicia combinations or other near-victory events), wagering pattern, and estimates or predictions of patron skill (e.g., skill scores, skill level categorizations, etc.). The gaming data 118A can include statuses of and changes to attributes 145, such as, for example, hitbox dimensions, reel rotation speed or other rendered object movement speeds, reel acceleration, reel rotation direction, indicia used during a wagering game, selection object speed, and selection object acceleration. The gaming data 118A can include associations between user accounts 124 and subsets of the historical gaming data 118A. For example, a subset of the gaming data 118A may be associated with a patron identifier corresponding to a user account 124.

The gaming data 118A can include historical data corresponding to previous wagering games. The gaming data 118A can include information associated with a user account 124 or patron with which a previous wagering game is associated. The gaming data 118A can include historical skill scores, skill levels, or inputs corresponding to one or more user accounts 124. The gaming data 118A can include statistical measures derived from historical gaming data, such as, for example, mean skill scores, skill score ranges, skill level threshold(s), skill score deviation, skill score percentiles, skill score variance, and skill score distribution.

The gaming data 118A can include historical inputs, metadata, and metrics derived therefrom. The metadata can include a timestamp corresponding to when the input was initiated. The metadata can a timestamp corresponding to when the input was executed. The metadata can include a latency value based on the aforementioned timestamps. The metadata can include a rotation duration corresponding to a period between initiation of reel movement and receipt of an input for stopping said movement. The metadata can include an indication of a particular wagering game with which the input is associated. The metadata can include an indication of a particular gaming device 106 at which the particular wagering game was initiated. The metadata can include attributes of the input, such as a location of the input on a touchscreen display or a location of the input relative to a particular region of a touchscreen display or content rendered thereon. The metadata can include metrics derived from the input and a location or timing of the input. For example, the metadata can include an accuracy metric based on a location of an input to a display relative to a hitbox (e.g., or relative to the position of an indicium to a particular region of the display). As another example, the metadata can include a precision metric based on positions of two or more historical inputs relative to each other and/or a particular region of a display (e.g., or relative to the position of an indicium to a particular region of the display).

The gaming data 118A can include associations between input devices 110 and reels or other controllable elements of wagering games. The gaming data 118A can include historical data associated with effect sources 114, such as, for example (de) activations of effect sources 114 or effect source settings (e.g., color, intensity, volume, activation frequency, activation period, etc.). The gaming data 118A can include mappings of the locations of gaming devices 106 (e.g., enabling the gaming system 103 to determine whether gaming devices 106 are within proximity to each other). The gaming data 118A can include play records that describe changes in wagering games being initiated at a gaming device 106 (e.g., on behalf of a particular patron or any suitable number of patrons) and/or changes in gaming devices 106 being used.

The pay table data 121 can include indicia, indicia combinations, and associations of indicia combinations to awards, such as points, currency, or other prizes. The indicia can be any media, including, but not limited to, images, videos, audio recordings, and combinations thereof. The indicia combinations can be any suitable sequence of indicia, including a sequence comprising a single indicium. The pay table data 121, or a pay table derived therefrom, can be stated or unstated.

The user account 124 can include authentication credentials, a user identifier, contact information, user preferences, or other identifying information. The user identifier can correspond to an identifier stored in a magnetic strip of a patron tracking card. In some embodiments, the gaming data 118A can correspond to an anonymous patron. As an example, a gaming session of an anonymous patron can be tracked as credits, inputs, input patterns, games played, tickets, or other trackable aspects are moved among gaming devices 106. The user account 124 can include one or more identifiers that associate the user account 124 with gaming data 118A. Based on input, such as a patron inserting a player's card with a patron identifier into a player tracking module, the game application 133 (e.g., or a system in communication therewith) can retrieve a user account 124 that corresponds to the patron identifier. For example, the gaming device 106 receives a patron identifier and retrieves a user account 124 and skill score 125 with which the patron identifier is associated. In another example, a ticket is inserted into the gaming device 106, and the game application 133 reads the ticket to retrieve a skill score 125 stored on the ticket. In yet another example, the patron identifier can be received via a mobile device using near field communication or read from an RFID tag, such as a RFID-tagged badge.

The user account 124 can include one or more skill scores 125. The skill score 125 can be a quantitative measure of a patron's ability to achieve a particular outcome, or any one of a set of outcomes, in a wagering game. The skill score 125 can include an association of the skill score 125 with a skill level, such as a low skill level, medium skill level, or high skill level. The skill score 125 can include metadata, such as a timestamp corresponding to the date of skill score generation or an identifier for a particular model 126 by which the skill score 125 was generated. The skill score 125 can include metadata comprising one or more attributes 145 and properties thereof that are associated with historical wagering games from which the skill score 125 was derived.

In some embodiments, in response to determining a predetermined time period has elapsed following the generation of the skill score 125 (e.g., 1 day, 6 weeks, 6 months, or any suitable period) has elapsed, the gaming service 115 determines whether any new gaming data 118A has been generated for the user account 124 following the generation of the skill score 125. In response to determining new gaming data 118A has been generated in the intervening period, the gaming service 115 can generate an updated skill score 125 or a new skill score 125 further based on, or exclusively based on, the new gaming data 118A.

The skill score 125 may be based on gaming data 118A corresponding to an entire history of a patron's engagement with the gaming system 103. The user account 124 can include a respective skill score 125 for each type of wagering game associated with the gaming system 103. The user account 124 can include an average skill score 125. The average skill score 125 may be a weighted or unweighted average of a plurality of historical skill scores 125. The plurality of historical skill scores 125 may be associated with a particular type of wagering game, a particular gaming location, a particular time period, or one or more particular attributes 145 (e.g., a particular reel speed, input device 110, indicia set, hitbox dimension(s), etc.).

The models 126 can include any suitable model or combination of models for analyzing gaming data 118A, generating skill scores 125, and/or predicting an effect of an attribute 145 or change thereto. The models 126 can include machine learning models and artificial intelligence models. The machine learning models can include, but are not limited to, topic modelers, neural networks, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and combinations thereof. Neural networks can include, but are not limited to, uni- or multilayer perceptron, convolutional neural networks, recurrent neural networks, long short-term memory networks, auto-encoders, deep Boltzman machines, deep belief networks, back-propagations, stochastic gradient descents, Hopfield networks, and radial basis function networks. The game application 133 can generate and train machine learning models using one or more training data sets. The training data set can be based on and/or include historical gaming data (e.g., corresponding to a particular user account or a plurality thereof), live gaming data, and simulated gaming data. The training dataset can be labeled, unlabeled, or a combination thereof.

The models 126 can include one or more model properties for configuring model performance. The model property can include any parameter, hyperparameter, configuration, or setting of the model 126. Non-limiting examples of properties include coefficients or weights of linear and logistic regression models, weights and biases of neural network-type models, cluster centroids in clustering-type models, train-test split ratio, learning rate (e.g. gradient descent), choice of optimization algorithm (e.g., gradient descent, gradient boosting, stochastic gradient descent, Adam optimizer, etc.), choice of activation function in a neural network layer (e.g. Sigmoid, ReLU, Tanh, etc.), choice of cost or loss function, number of hidden layers in a neural network, number of activation units (e.g., artificial neurons) in each layer of a neural network, drop-out rate in a neural network (e.g., dropout probability), number of iterations (epochs) in training a neural network, number of clusters in a clustering task, Kernel or filter size in convolutional layers, pooling size, and batch size.

The models 126 can include data for evaluating skill scores 125. The models 126 can include one or more predetermined thresholds for determining modifications to one or more attributes based on a skill score 125. The models 126 can include one or more predetermined thresholds for associating a user account 124 with one of a plurality of skill levels based on a skill score 125. The models 126 can include calibration curves or other relational data for classifying or categorizing a user account 124 based on a skill score 125.

The gaming service 115, or game application 133, can generate and train the models 126, including adjusting one or more properties of the models 126 to improve the performance thereof (e.g., increasing accuracy, precision, stability, and/or speed, and/or reducing error). The gaming service 115 can generate training datasets and/or validation datasets based on the gaming data 118A, 118B, and potentially other data. The dataset can include labeled data, unlabeled data, or a combination thereof. For example, a labeled training dataset can include gaming data 118A, 118B including historical user inputs for a plurality of historical wagering games and an outcome of each of the historical wagering games. In another example, an unlabeled training dataset includes gaming data 118A, 118B corresponding to a plurality of historical wagering games and excludes the outcome of each historical wagering game.

The gaming service 115 can iteratively generate and train the model 126 to generate an iteration of the model 126 that demonstrates sufficient performance, such as satisfying one or more thresholds for evaluating model accuracy, error, precision, stability, or combinations thereof. The gaming service 115 can retrain the model 126 as new gaming data 118B is obtained from one or more gaming devices 106. The gaming service 115 can generate and train a model 126 for each type of wagering game provided by the gaming device 106. The gaming service 115 can stored the model 126 in association with one or more patron identifiers, one or more gaming device identifiers, one or more wagering game type identifiers, and potentially other data.

The gaming service 115 can generate skill scores 125 by processing gaming data 118A, 118B via the model 126. The gaming service 115 can generate the skill score 125 based on a subset of gaming data 118A, 118B corresponding to a user account 124 and/or patron identifier. The gaming service 115 can determine one or more modifications to attributes 145 of a wagering game based on one or more skill scores 125. The gaming service 115 can generate and train models 126 to predict an effect of a modification to one or more attributes 145 on an outcome of a wagering game. The gaming service 115 can apply predetermined policies to determine modifications to one or more attributes 145 based on the skill score 125. The predetermined policies may relate various modifications to attributes 145 to varying skill scores 125. The predetermined policies can be stored at the data store 112, such as in one or more user accounts 124 or as a standalone element.

The gaming service 115 can transmit skill scores 125 and modifications to attributes 145 to the gaming device 106. The gaming service 115 can perform various actions on behalf of the gaming device 106 including, but not limited to, patron authentication, skill score generation, attribute modification determination, and award determination (e.g., based on wagering game outcome). The gaming service 115 can generate gaming data 118A including time-series records of any activities occurring at the gaming device 106, including, but not limited to, wagering game outcomes, user inputs, and awards.

The gaming device 106 is representative of a plurality of gaming devices that may be coupled to the network 109. The gaming device 106 can include, for example, an amusement device, a slot machine, or other gaming device with a processor-based system such as a computer system. Such a computer system may be embodied in the form of a computing device in a slot machine cabinet, a desktop computer, a laptop computer, personal digital assistants, cellular telephones, smartphones, set-top boxes, music players, web pads, tablet computer systems, game consoles, electronic book readers, or other devices with like capability.

The gaming device 106 can include, but is not limited to, a data store 130, a game application 133, one or more display devices 108, one or more input devices 110, and one or more effect sources 111, among other components. The data store 130 can store gaming data 118B, attributes 145, and potentially other data, such as a patron identifier or skill score 125. Non-limiting examples of attributes 145 include reel rotation speed, reel rotation direction, reel dimension (e.g., width, height, virtual depth), indicia displayed on the reel, reel orientation (e.g., vertical orientation, horizontal orientation, or any angle of reel rotation there between), reel acceleration (e.g., a reel may rotate faster or slower depending on one or more factors, such as a predetermined acceleration rate and/or which of a plurality indicia are currently stated or unstated), and association of a reel with one of a an input device 110. Additional examples of attributes 145 include, but are not limited to hitbox attributes (e.g., dimension(s), availability, distribution, etc.), input device settings (e.g., latency, mapping of input device to one or more reels, input requirements for controlling reels, etc.), and one or more settings of the effect source 111 (e.g., (de) activation, intensity, frequency, duration, etc.).

The display device 108 can include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc. The input device 110 can include, but is not limited to, a buttons, a lever, a touch screen (e.g., including three-dimensional or pressure-based touch screens), a camera, a biometric capture device (e.g., fingerprint scanner, facial scanner, etc.), an accelerometer, a gesture tracking device, a gyroscope, a magnetometer, or other input device. The input device 110 can also include a bill acceptor, a player tracking module, a ticket printer, and potentially other devices.

The effect source 111 can include, but is not limited to, light sources, audio sources, kinetic sources, and combinations thereof. The light source can include, but are not limited to, one or more displays (e.g., displays of the gaming device, displays adjacent to the gaming device, displays of additional gaming devices, etc.), light fixtures, light-emitting diode (LED) strips, dimmer switches, and other light-emitting or light emission-modulating elements. The audio sources can include, but are not limited to, speakers, musical instrument digital interface (MIDI) control elements, electronic instruments, and other audio-related elements. The kinetic sources can include, but are not limited to, animatronics, hydraulic or pneumatic elements, and other elements configured for electromechanical motions or other motions.

The gaming device 106 can be configured to execute various applications, such as the game application 133 and/or other applications. The game application 133 may be executed in a gaming device 106, for example, to access network content served up by the gaming system 103, and/or other servers, thereby rendering various user interfaces on the display device 108. As an example, the game application 133 can render a plurality of reels on the display device 108 (e.g., each reel including a subset of a plurality of indicia). In some embodiments, the game application 133 can include, for example, a browser, a dedicated application, etc., and the user interface can be a network page, an application screen, etc. The gaming device 106 can be configured to execute applications beyond the gaming application 133 such as, for example, a patron tracking service window application, email applications, social networking applications, word processors, spreadsheets, and/or other applications.

The gaming device 106, via the game application 133, can initiate and resolve wagering games, such as skill stop games. The game application 133 can render a plurality of reels on the display device 108 (e.g., the rendering of each reel including a subset of a plurality of indicia). The game application 133 can rotate the plurality of reels on the display device 108. The game application 133 can stop the rotation of the plurality of reels based on one or more user inputs. The game application 133 can determine an outcome of the wagering game based on the stopped position of each of the plurality of reels. For example, the game application 133 can identify a sequence of aligned indicia from the plurality of reels and determine the outcome based on the sequence as compared to pay table data 121.

The game application 133 can retrieve a skill score 125 based on a patron identifier. The game application 133 can transmit a patron identifier to the gaming service 115. The gaming service 115 can generate or retrieve a skill score 125 based on the patron identifier. In an exemplary scenario, the input device 110 receives an input including a patron identifier. In response to the input, the game application 133 retrieves a skill score 125, adjusts one or more attributes 145 of a wagering game based on the skill score 125, and initiates and resolves the wagering game (e.g., including rendering the wagering game, receiving an input to the wagering game, and determining an outcome of the wagering game based on the input, or action(s) caused thereby). Over a period of play, the gaming device 106 receives four commands to initiate wagering games generates a total of four wagering game outcomes throughout the period of play. Before each wagering game, the game application 133, or gaming service 115, recalculates a skill score 125 based on gaming data 118A, 118B corresponding to the preceding wagering games. For each wagering game, the game application 133 adjusts or maintains one or more attributes 145 based on the corresponding skill score 125 determined for said wagering game.

The game application 133 can process historical gaming data 118A, 118B and determine a subset of the historical gaming data associated with a particular user account 124. The historical gaming data 118A, 118B can include, for example, outcomes of historical wagering games. The subset of the historical gaming data 118A, 118B can include one or more outcomes of historical wagering games associated with the particular user account 124. Further non-limiting examples of the historical gaming data 118A, 118B, or subset thereof, include user inputs, payout values, coin-in contributions, attributes 145, and metadata, such as timestamps for historical gaming data 118A, 118B.

The game application 133, or gaming service 115, can determine a skill score 125 corresponding to the particular user account 124 based at least in part on the historical gaming data 118A, 118B and/or the subset of the historical gaming data 118A, 118B associated with the particular user account 124. The game application 133 can analyze historical gaming data 118A, 118B via one or more suitable algorithms, models (e.g., including models 126), techniques, or combinations thereof. Non-limiting examples of analysis algorithms, models, or techniques include statistical measures, rating or ranking systems, probability tests or metrics, and predictive classification or categorization models. The statistical measures can include, but are not limited to, mean, median, mode, standard deviation, range, percentile, variance, statistical distance, correlation coefficient, distribution, error function, and results of statistical tests (e.g., chi-squared, f-test, t-test, ANOVA, etc.). The statistical measure can be weighted or unweighted. The rating or ranking systems can include, but are not limited to, Elo, TrueSkill, Glicko, and Glicko-2.

The skill score 125 can be a quantitative measure of a patron's likelihood or historical ability to achieve a particular outcome, or set of outcomes, in one or more wagering games. In some embodiments, the game application 133 assigns a user account 124, or a current gaming device 106 associated therewith, to a skill level based on the skill score. For example, a first, lowest range of skill score values may be associated with a low skill level, a second, greater range of skill score values may be associated with a medium skill level, and a third, greatest range of skill score values may be associated with a high skill level. The game application 133 can generate a skill score for a user account 124 by determining and processing the subset of historical gaming data 118A, 118B corresponding to the user account 124. The game application 133 can determine that the skill score falls within the third range and, based thereon, assign the user account to the high skill level.

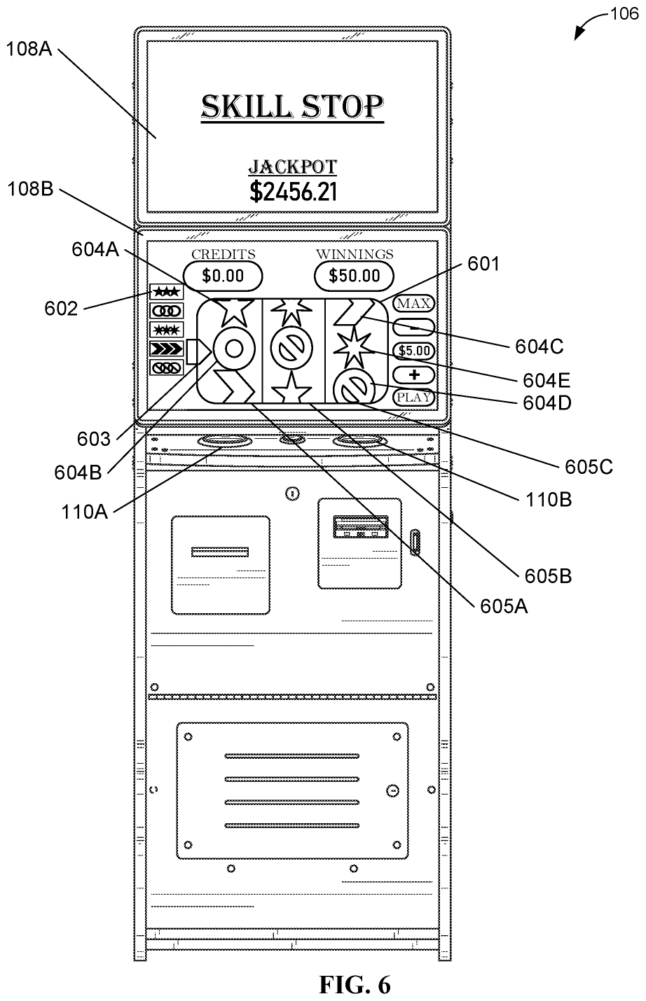

The game application 133 can render, on the display device 108, one or more reels. The reel can include a plurality of indicia, such as a set of assorted symbols (see, e.g., gaming device 106 shown in FIG. 6 and described herein). The game application 133 can render, on the display device 108, a subset of the plurality of indicia (e.g., a first subset of the indicia may be stated, and a second subset may be unstated). The stated subset of the plurality of indicia can be mutually exclusive with a remaining, unstated subset of the plurality of indicia. In some embodiments, the subset of the stated plurality of indicia is non-mutually exclusive with a remaining, unstated subset of the plurality of indicia (e.g., a reel may include multiple instances of the same indicium).

The game application 133 can modify one or more attributes 145 of a reel, or one or more indicia thereof, based on a skill score 125. The game application 133 can render different indicium with identical or different dimensions (e.g., width, height, virtual depth, etc.). For example, the game application 133 can render a first indicium such that, on the display, the first indicium comprises a pixel height of 200 pixels. In the same example, the game application 133 can render a second indicium such that the second indicium comprises a pixel height of 400 pixels. The reel can include a plurality of indicia. The game application 133 can arrange the plurality of indicia in a sequence. For example, the game application 133 vertically arranges the plurality of indicia, thereby generating a column of indicia. In another example, the game application 133 horizontally arranges the plurality of indicia, thereby generating a row of indicia. The reel can comprise a sequence of pixels. The game application 133 can iteratively move a selector throughout the sequence of pixels. For example, a reel includes a vertical pixel height of 1000 pixels and each indicium of the reel comprises 200 pixels (e.g., a first indicium comprises pixels 1-200, a second indicium comprises pixels 201-400, etc.). The game application 133 can render the reel on the display. The game application 133 can rotate the reel on the display such that the indicia of the reel are moved to different pixel positions as a function of time.

The game application 133 can increase or decrease the rate of the reel rotation. The game application 133 can increase or decrease the rate by which the rate of the reel rotation changes (e.g., the game application 133 can adjust reel acceleration and deceleration). The game application 133 can change the direction of reel rotation. For example, the game application 133 can rotate the reel in a first direction for a first period and rotate the reel in a second direction for a second period (e.g., or until the game application 133 receives an input that causes the game application 133 to cease rotation of the reel). The game application 133 can different reels in different directions. For example, the game application 133 rotates a first reel in a clockwise direction and a second reel in a counterclockwise direction. In another example, the game application 133 renders a first reel in a horizontal orientation and rotates the first reel in a horizontal direction (e.g., the first reel rotates about an axis extending in a vertical direction). In the same example, the game application 133 renders a second reel in a vertical orientation and rotates the second reel in a vertical direction (e.g., the second reel rotates about an axis extending in a horizontal direction).

The game application 133 can associate control over reel rotation with an input device 110. For example, the game application 133 can associate a reel with an input device such that, in response to receiving an input to the input device, the game application 133 rotates or ceases the rotation of the reel. The game application 133 can associate control of multiple reels with a single input device. The game application 133 can associate control of each of a plurality of reels with a different respective input device. For example, the game application 133 can associate control of a first reel's rotation with a first button, control of a second reel's rotation with a second button, and control of a third reel's rotation with a third button.

The game application 133 can sequentially associate control of rotation for multiple reels with the same input device. For example, the game application 133 associates rotations of three reels with a single input device. In response to receiving a first input to the input device, the game application 133 can stop rotation of the first reel. In response to receiving a second input to the input device (e.g., subsequent to receiving the first input), the game application 133 can stop rotation of the second reel. In response to receiving a third input to the input device (e.g., subsequent to receiving the second input), the game application 133 can stop rotation of the third reel. The game application 133 can disassociate control of a reel from a first input device and reassign the control of the reel to a second input device. For example, the game application 133 disassociates control of a reel from a first button and associates control of the reel with a second button. In another example, the game application 133 disassociates control of a reel from a button-type input device and associates control of the reel with a lever-type input device (e.g., or other input device types, such as a gesture-based input device, a voice-controlled input device, or a mobile application-based input device).

The game application 133 can configure a latency period for processing inputs to an input device. The latency period can correspond to a length of time between when an input to the input device is received and when a corresponding action is executed. For example, the game application 133 can configure a latency period to 1 second (e.g., or 500 milliseconds, 300 milliseconds, or any suitable value) such that, when the game application 133 receives an input via an input device, the game application 133 continues to rotate the corresponding reel for 1 second post-input receipt before stopping rotation of the reel. The game application 133 can increase or decrease the latency period. The game application 133 can adjust the latency period associated with a second reel in response to a stopped position of a first reel. For example, in response to a first input, the game application 133 stops rotation of a first reel. Based on the stopped position of the first reel (e.g., or the position of one or more indicia thereon), the game application 133 can increase, decrease, or maintain a latency period of a second reel. The game application 133 can adjust the latency period of one or more reels based on a skill score or skill level of a user account. For example, in response to a user account being associated with a high skill score, the game application 133 can increase the latency period or reassign the latency period from a current value to a pseudo-randomly generated value.

The game application 133 can associate control of a reel with multiple input devices. For example, the game application 133 can associate control of reel rotation with a plurality of input devices such that control of the reel is exercised via an input to any one of the plurality of input devices. In another example, the game application 133 associate control of reel rotation with a plurality of input devices such that control of the reel is exercised only via an input from each of the plurality of input devices, or a predetermined subset thereof. The gaming service can communicate with a first game application 133 of a first gaming device and a second gaming application of a second gaming device such that one or more input devices of the first gaming device may be used to control one or more reels of the second gaming device (e.g., or vice versa). The gaming service can communicate with the first game application 133 and the second game application 133 such that an input at an input device of the first gaming device results in cessation or initiation of rotation for one or more reels of the second gaming device.

The game application 133 can initiate one or more effects via the effect source 111. The game application 133 can initiate the effect based on one or more factors including, but not limited to, initiation of a wagering game at the gaming device or a second gaming device, outcome of a wagering game at the gaming device or a second gaming device, position of a reel, position of one or more indicia of a reel, skill score corresponding to a user account, skill level with which a user account is associated, input(s) to one or more input devices, and combinations thereof. The game application 133 can initiate the effect pseudo-randomly. The game application 133 can initiate the effect when a particular indicia is at a predetermined position relative to a hitbox, or vice versa. For example, the game application 133 initiates the effect when a particular indicia is at a position outside of a hitbox and within a predetermined proximity of the hitbox (e.g., 200 pixels, 50 pixels, or any suitable number of pixels from the hitbox in a horizontal, vertical, or any suitable direction). The game application 133 can initiate the effect when a selection object (e.g., stated or unstated) is within a predetermined time period of moving into the hitbox, leaving the hitbox, or following movement out of the hitbox. For example, in response to a selection object moving within a predetermined number of pixels of a hitbox for a particular indicium, the game application 133 activates the effect source 111.

The game application 133 can determine an outcome of a wagering game. The game application 133 can determine the outcome of a wagering game based on a stopped position of one or more reels (e.g., or the stopped position of indicia included thereon). The game application 133 can determine the outcome of the wagering game based on one or more indicia that, upon stoppage of the one or more reels, are aligned with a pay line or selection object. The game application 133 can detect a collision between a selection object and a hitbox corresponding to an indicium of a reel. The game application 133 can stop the reel at a particular position corresponding to the particular indicia and the hitbox. The selection object may be stated or unstated to the patron. The selection object can be a moving region of “active” pixel positions relative to pixels comprising a set of indicia. During a wagering game, the game application 133 can move the selection object along the set of indicia such that the selection object moves to different pixel positions as a function of time. The game application 133 can stop the movement of the selection object in response to an input device 110, and potentially other data, such as an attribute 145 (e.g., a latency period, input-to-input device mapping, etc.). The collision of a selection object and a hitbox can refer to an alignment between pixel position of the selection object and a region of pixels that define the hitbox. The game application 133 can ignore a collision between a selection object and a hitbox in response to the hitbox being outside of an “availability period.” The availability period can be any suitable time period (e.g., 50 milliseconds, 1 millisecond, or any suitable value) during which the hitbox is configured to an “active” state. In response to determining the collision of a selection object with the hitbox during the availability period, the game application 133 can stop a moving reel at a particular position corresponding to an indicium with which the hitbox is associated.

Before turning to the processes shown in FIGS. 3-5, it is noted that embodiments described herein may be practiced using an alternative order of the steps illustrated in FIGS. 3-5. That is, the process flows illustrated in FIGS. 3-5 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope of the embodiments. The usage of various attributes 145 and indicia herein are for illustrative purposes only and other attributes or indicia can be used. The state of one or more attributes 145 can be set by the gaming service 115. In some embodiments, the state of one or more attributes 145 is fixed by regulators. In some embodiments, an administrator can manually configure one or more attributes 145.

With reference to FIG. 3, shown is a flow chart of a skill determination process 300 according to various embodiments of the present disclosure. The gaming service 115, or game application 133, can perform the process 300 to generate or update a skill score 125.

At box 303, the process 300 can include obtaining gaming data 118A, 118B. The gaming service 115 can obtain the gaming data 118A, 118B from the data store 112, the data store 130, and potentially other sources, such as one or more external systems or othering gaming systems 103. In one example, the gaming service 115 retrieves a subset of gaming data 118A from the data store 112. The gaming service 115 can retrieve the gaming data 118A based on one or more factors, including, but not limited to, a patron identifier or identifier associated with a user account 124, authentication data associated with a user account 124 (e.g., credentials, biometric data of a patron, etc.), an identifier associated with a gaming device 106, and combinations thereof. The gaming service 115 can request and receive gaming data 118B from one or more gaming devices 106. For example, the gaming service 115 transmits a patron identifier to a gaming device 106 that retrieves and transmits the gaming data 118B to the gaming service 115 based on the patron identifier.

The gaming service 115 can obtain the gaming data 118A, 118B in response to a user input, such as a gaming device 106 receiving an input via the input device 110. For example, in response to a patron inserting a ticket into the gaming device 106, the game application 133 can determine a patron identifier based on the ticket. The gaming service 115 can receive the patron identifier from the game application 133 and retrieve the gaming data 118A, 118B based on the patron identifier.

The gaming service 115 can obtain the gaming data 118A, 118B in response to completion of one or more wagering games at one or more gaming devices 106. For example, in response to the game application 133 determining an outcome of a wagering game, the gaming service 115 receives gaming data 118B associated with the wagering game (e.g., or additional wagering games at the gaming device 106). The gaming service 115 can automatically obtain gaming data 118A, 118B in response to completion of a wagering game (e.g., to update a skill score 125 and modify one or more attributes 145 of a subsequent wagering game based on the updated skill score 125). The gaming service 115 can retrieve the gaming data 118A, 118B in response to completion of a predetermined number of wagering games (e.g., 2, 5, 10, or any suitable number) at one or more gaming devices 106.

The gaming service 115 can obtain the gaming data 118A, 118B in response to generating a new user account 124 (e.g., such as when a new patron initiates a first wagering game, completes registration process, or initiates a first payout event). The gaming service 115 can determine that a predetermined threshold is satisfied and, in response, obtain the gaming data 118A, 118B. For example, in response to determining that a total award amount of one or more gaming devices 106 meets a predetermined threshold amount (e.g., within a suitable predetermined time period, such 1 hour, 1 day, etc.), the gaming service 115 obtains the gaming data 118A, 118B. As another example, in response to determining that a number of a particular outcome of wagering games at the gaming device 106 meets a predetermined threshold, the gaming service 115 obtains gaming data 118A, 118B.

At box 306, the process 300 can include processing the gaming data 118A, 118B. The gaming service 115 can identify a subset of the gaming data 118A, 118B based on one or more factors including, but not limited to, particular gaming device(s) 106, particular type(s) of wagering game, particular user account(s) 124, particular patron identifier(s), time period, location (e.g., a region of a gaming area, a particular gaming area, etc.), particular wagering game outcome(s) (e.g., particular sequence of indicia, particular award, etc.), particular state of or change to one or more attributes 145, and particular skill score(s) 125 or range thereof. In one example, the gaming service 115 determines a subset of the gaming data 118A, 118B that corresponds to one or more outcomes for one or more historical wagering games associated with a particular user account 124. In another example, the gaming service 115 determines a subset of the gaming data 118A, 118B that corresponds to historical user inputs associated with a particular user account 124. In another example, the gaming service 115 determines a subset of the gaming data 118A, 118B corresponding to a particular user account 124 over a particular time period, such as 1 day, 6 weeks, 6 months, or any suitable period.

The gaming service 115 can process the gaming data 118A, 118B to determine a subset thereof corresponding to a particular attribute 145, or set of attributes 145, present during one or more historical wagering games. The gaming service 115 can process the gaming data 118A, 118B to determine a subset thereof corresponding to one or more particular skill scores 125, one or more particular skill levels, or a particular range of skill score 125 or skill level.

At box 309, the process 300 can include analyzing the gaming data 118A, 118B. The gaming service 115 can generate analyze the gaming data 118A, 118B to generate one or more statistical measures, such as, for example, variance, mean, standard deviation, or distribution. The gaming service 115 can perform pattern detection processes to characterize relationships between subsets of the gaming data 118A, 118B, such as a relationship between historical skill score(s) 125 and historical wagering game outcomes. For example, the gaming service 115 can generate a function for a regression line, or other line of best fit, for relating subsets of the gaming data 118A, 118B. The gaming service 115 can perform one or more operations to transform the gaming data 118A, 118B into a format suitable for processing via one or more models 126. The operation can include, but is not limited to, outlier removal, null value removal, value imputation, normalization, and labeling.

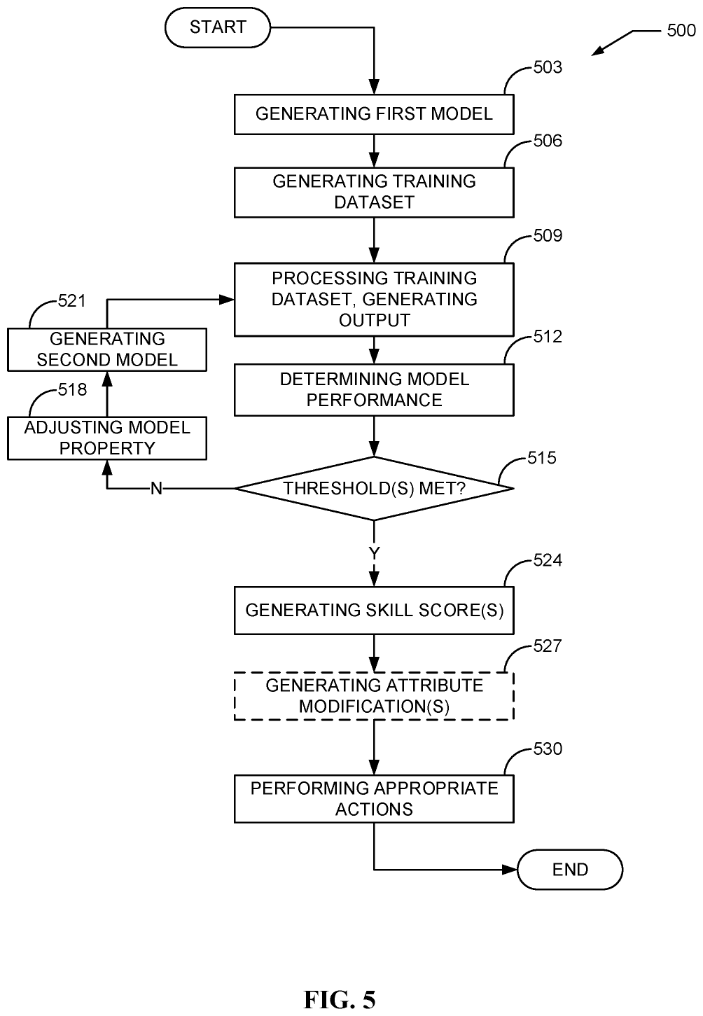

The process 300 can include performing one or more model generation processes 500 as shown in FIG. 5 and described herein. The gaming service 115, via the process 500, can train a model 126 to generate a skill score 125 based on the gaming data 118A, 118B, or one or more subsets thereof determined at box 309. The gaming service 115 can generate or retrieve the model 126 based on one or more factors including, but not limited to, a patron identifier, the gaming device 106 from which the patron identifier was received, a user account 124, or a type of wagering game to be initiated at the gaming device 106.

At box 312, the process 300 can include generating one or more skill scores 125 (e.g., and/or or other suitable measure of patron skill). The gaming service 115 can generate the skill score 125 based on the gaming data 118A, 118B, or subset thereof determined at box 309. The gaming service 115 can process the subset of gaming data 118A, 118B via the model 126 to generate the skill score 125. In some embodiments, the gaming service 115 generates a plurality of skill scores 125 that each correspond to a different subset of the gaming data 118A, 118B. The different subsets of the gaming data 118A, 118B can correspond to differing factors including, but not limited to, different time periods, different gaming devices 106, different types of wagering games, and different attributes 145 or states thereof. The gaming service 115 can generate a weighted or unweighted average of a plurality of first skill scores 125 to generate a second skill score 125. The gaming service 115 can generate a second skill score 125 based on a first skill score 125 by normalizing or calibrating the first skill score 125 via a normalization function, calibration curve, or other suitable technique, model, or algorithm.

At box 315, the process 300 can include storing the one or more skill scores 125 generated at box 312. The gaming service 115 can store the skill score 125 in a user account 124 corresponding to a patron identifier. The gaming service 115 can store the skill score 125 in gaming data 118, potentially among additional skill scores 125 associated with the gaming device 106 and/or a particular type of wagering game. The gaming service 115 can initiate a meter corresponding to the generation of the skill score 125, such as a timer or usage counter. The gaming service 115 can modify or replace a previously stored skill score 125 based on the new skill score 125. The gaming service 115 can store, at the data store 112, information related to the generation of the skill score 125, such as, for example, the gaming data 118A, 118B from which the skill score 125 was derived or the model 126 by which the skill score 125 was generated.

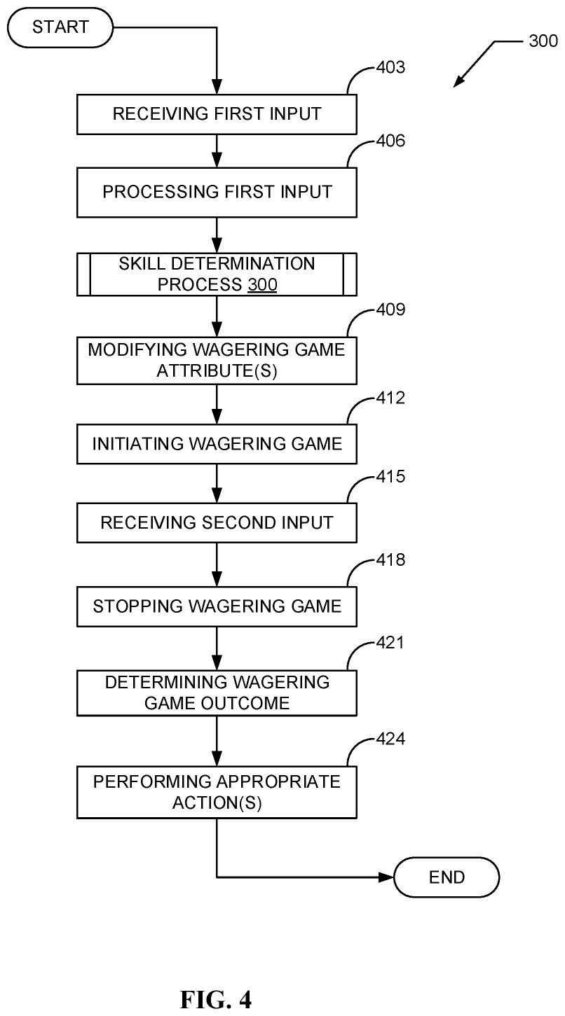

At box 318, the process 300 can include performing one or more appropriate actions. For example, the gaming system 103 and/or gaming device 106 can perform a gaming process 400 as shown in FIG. 4 and described herein. The gaming service 115 can transmit the skill score 125 to the gaming device 106 (e.g., or vice versa, if the skill score 125 is created via the game application 133). The gaming service 115 can determine one or more modifications to one or more attributes 145 based on the skill score 125. The game application 133 can receive or determine the modifications to the one or more attributes 145. The game application 133 can modify the one or more attributes 145. The game application 133 can initiate a wagering game based on the skill score 125 and the one or more modified attributes 145.

The gaming service 115 can modify a patron identifier or other aspect of a user account 124 based on the skill score 125. For example, based on the skill score 125, the gaming service 115 can reassign a user account 124 from a first skill level to a second skill level. The gaming device 106 can print a ticket that encodes the patron identifier and the skill score 125.

With reference to FIG. 4, shown is a flow chart of a gaming process 400 according to various embodiments of the present disclosure.

At box 403, the process 400 can include receiving a first input. The first input can be a plurality of inputs to a gaming device 106 or a system in communication with the gaming device 106 or the gaming system 103. The game application 133 can receive the first input via one or more input devices 110. The first input can include a request to initiate a wagering game at the gaming device 106. The first input can include an amount of coin-in or other cost of initiating the wagering game. The first input can include a patron identifier and/or other information by which a user account 124 may be identified and/or authenticated. The first input can include a ticket or other scannable media from which a patron identifier may be obtained. The first input can include credentials, such as, for example, a username and/or password or biometric data.

At box 406, the process 400 can include processing the first input. The game application 133 can generate a new user account 124 in response to the first input, including generating a patron identifier corresponding to the new user account 124. The game application 133 can initialize a skill score 125 of the new user account 124 to a particular value, such as a preset value or an average of skill scores 125 of other user accounts 124.

The game application 133 can determine a user account 124 based on the patron identifier. The game application 133 can authenticate the user account 124 based on the patron identifier and/or other data, such as one more credentials. The game application 133 can retrieve a skill score 125 based on the patron identifier or user account 124. The game application 133 can determine whether one or more meters corresponding to the retrieved skill score 125 are satisfied. For example, the game application 133 determines whether a predetermined time period has elapsed following generation of the retrieved skill score 125 (e.g., and, if so, may generate a new skill score 125). In another example, the game application 133 determines that the skill score 125 is associated with a predetermined number of historical wagering games and/or a predetermined amount of historical awards.

The process 400 can include performing one or more skill determination processes 300 as shown in FIG. 3 and described herein. The game application 133, or gaming service 115, can perform the process 300 to retrieve gaming data 118A, 118B based on the first input (e.g., or data derived therefrom or retrieved based thereon), generate or update a skill score 125, and, in some embodiments, determine one or more modifications to one or more attributes based on the skill score 125.

At box 409, the process 400 can include modifying one or more attributes 145 of the wagering game requested via the first input. The game application 133 can modify the attribute(s) 145 to increase or decrease the difficulty of the wagering game based on the skill score 125. For example, based on a low skill score 125, the game application 133 increases one or more dimensions of a hitbox corresponding to a particular indicium of a plurality of indicia associated with the wagering game, thereby increasing the probability of a patron obtaining an outcome corresponding to the particular indicium. In another example, based on a high skill score 125, the game application 133 reassigns control of a wagering game reel, plurality thereof, from a first input device 110 to one or more alternative input devices 110. In another example, based on a high skill score 125, the game application 133 reconfigures a reel rotation acceleration from a fixed value to a changing value, thereby increasing the difficulty of the wagering game by reducing the probability of achieving any particular outcome. In another example, based on a high skill score 125, the game application 133 reduces one or more dimensions of a hitbox corresponding to a particular indicium of a plurality of indicia. In another example, based on a low skill score 125, the game application 133 reduces a latency for processing inputs from the input device 110.

In another example, based on a high skill score 125, the game application 133 activates one or more effect sources 111 based on one or more settings corresponding to the skill score 125 (e.g., activation duration, activation frequency, activation intensity, activation trigger, etc.). In a particular example, the game application 133 applies an activation trigger such that, during rotation of a reel including a plurality of indicia, the effect source 111 activates when a particular indicium of the plurality of indicia is positioned at a particular region of the display device 108.

The game application 133, or gaming service 115, can determine the modification(s) to the attribute 145 by applying one or more policies to the skill score 125. For example, the game application 133 applies a reel rotation speed policy to the skill score 125 and, based on the value thereof, modifies a reel rotation speed of the wagering game from a first value to a second value. The game application 133 can compare the skill score 125 to one or more predetermined thresholds and modify the one or more attributes based on the comparison(s). The game application 133, or gaming service 115, can determine the modification(s) to the attribute by processing the skill score 125 via one or more models 126. For example, the game application 133 determines a rotation reel speed by processing the skill score 125 via a trained machine learning model. In another example, the game application 133 determines a set of indicia for use in the wagering game by processing the skill score via a trained machine learning model. In another example, the game application 133 determines one or more dimensions of a hitbox based on the skill score 125 and a calibration function or table (e.g., which may be preset or generated via a model 126 based on historical gaming data 118A, 118B).

At box 412, the process 400 can include initiating a wagering game (e.g., the wagering game including the one or more attribute modifications of box 409). The game application 133 can generate or retrieve a plurality of indicia. The game application 133 can render, on the display device 108, a reel comprising a subset of the plurality of indicia (e.g., including any modifications to attributes thereof). The game application 133 can render the indicia in any suitable orientation or position on the display device 108 (e.g., and the rendering thereof can be based upon one or more modified attributes 145). The game application 133 can rotate the subset of the plurality of indicia on the reel on the display device 108 (e.g., which may result in obfuscation of all or a portion of the subset of the plurality of indicia and corresponding rendering of one or more additional subsets of the plurality of indicia). The game application 133 can rotate the indicia at any suitable speed, acceleration, acceleration pattern, or direction (e.g., which may be based upon one or more modified attributes 145). The game application 133 can (de) activate or modify one or more effect sources 111 during the wagering game (e.g., based on attributes 145). The game application 133 can adjust one or more settings of one or more input devices 110 during the wagering game, including, for example, temporarily (de) activating the input device 110 or reassigning control of a reel from a first input device 110 to a second input device 110.

At box 415, the process 400 can include receiving one or more secondary inputs via the input device 110. The secondary input can be a user input for stopping rotation of the reel or otherwise influencing and/or precipitating resolution of the wagering game. The secondary input can include, but is not limited to, pressing a button, manipulating a lever, providing a touch input to the display device 108 or an input device 110, providing an input to a virtual gaming element (e.g., via an input device 110), performing a gesture, or providing a voice command. The game application 133 may require multiple secondary inputs to resolve a wagering game. For example, to proceed to box 418, the game application 133 may require receipt of an input via a first input device 110 and a second input via a second input device 110.

At box 418, the process 400 can include stopping the wagering game based on the one or more secondary inputs of box 415 and/or a current value of one or more attributes 145 (e.g., selection object position, selection object availability, hitbox collision, input latency, etc.). The game application 133 can stop the movement of one or more elements of the wagering game based on the secondary input, such as, for example, one or more reels or one or more selection objects. The game application 133 can process the secondary input based on a predetermined latency period, thereby continuing to rotate the corresponding wagering game element until conclusion of the predetermined latency period. The game application 133 can stop a selection object based on the secondary input. The game application 133 can determine a collision of the stopped selection object with a hitbox of a particular indicium of a plurality of indicia rendered on the reel based on a current position of the reel at time of receipt of the secondary input (e.g., or following a latency period). The game application 133 can stop rotation of the reel based on the current position and corresponding to the particular indicium with which the hitbox is associated. The game application 133 can stop all reels based on the secondary input. The game application 133 can stop each of a plurality of reels respectively based on a corresponding secondary input. The game application 133 can stop a first subset of a plurality of reels based on a first subset of secondary inputs and stop a second subset of the plurality of reels based on a second subset of secondary inputs. For example, based on a first user input, the game application 133 stops rotation of two of three rotating reels (e.g., while continuing to rotate the third reel on the display device 108). In the same example, based on a second user input, the game application 133 stops rotation of the third rotating reel.

At box 421, the process 400 can include determining an outcome of the wagering game. The game application 133, or gaming service 115, can determine the outcome of the wagering game based on one or more factors including, but not limited to, a stopped position of one or more reels, or indicia rendered thereon, an alignment of one or more indicia relative to additional indicia and/or a predetermined region of the display device 108, and a position of one or more selection objects relative to one or more indicia, or hitboxes associated therewith. The game application 133 can determine the outcome of the wagering game, for example, by comparing a plurality of indicia that are in alignment with a pay line of the display device 108 to pay table data 121 (e.g., which may or may stated or unstated). The game application 133 can determine the outcome of the wagering game based on collisions of one or more selection objects with one or more hitboxes corresponding to a subset of a plurality of indicia rendered on the display device 108. The game application 133 can perform one or more nudge operations to change the outcome of a wagering game from a non-winning outcome, or lesser winning outcome, to a winning outcome (e.g., a sequence of indicia associated with an award), or greater wining outcome. The game application 133 can perform the nudge operation based on the skill score 125. For example, in response to the skill score 125 meeting a predetermined threshold, the game application 133 adjusts a position of one or more indicia on the display device 108 to provide a particular outcome (e.g., winning outcome, non-winning outcome, lesser winning outcome, or greater winning outcome). The game application 133 can identify and record a near-miss event, such as when a sequence of indicia is similar but not identical to a winning sequence of indicia (e.g., one, two, or any suitable number of indicia, or positions thereof, short of a winning sequence of indicia).

At box 424, the process 400 can include performing one or more appropriate actions. The game application 133 can provide an award to the patron based on the outcome of box 421 and pay table data 121. The game application 133 can transmit the outcome of the wagering game to the gaming service 115. The gaming service 115 can determine an award based on the outcome and pay table data 121. The gaming service 115 can apply the award to a user account with which the patron is associated. The gaming service 115 can transmit the award to the gaming device 106. The game application 133 can print a ticket (e.g., or provide or update other storage media) that includes the award and the patron identifier. The game application 133 can generate and store gaming data 118B corresponding to the wagering game, the outcome of the wagering game, the attributes 145 of the wagering game, the skill score 125 associated therewith, and/or inputs associated with the wagering game. The gaming service 115 can receive and store the gaming data 118B as gaming data 118A at the data store 112. The game application 133, or gaming service 115, can store the gaming data 118B, or gaming data 118A, in association with one or more identifiers, such as the patron identifier, an identifier of the gaming device 106, an identifier associated with the type of wagering game, and potentially other identifiers.

The gaming service 115 can generate or train one or more models 126 based on gaming data 118A, 118B corresponding to the wagering game. For example, the gaming service 115 performs a second iteration of the process 500 shown in FIG. 5 and described herein to generate a new model 126 or modify a previous iteration of a model 126 based on the gaming data 118A, 118B corresponding to the wagering game. The gaming service 115 can generate a new skill score 125 or modify the patron's current skill score 125 based on the gaming data 118A, 118B. The gaming service 115 can store the new or modified skill score 125 in association with the patron's user account 124.

The game application 133 can activate one or more effect sources 111 based on the outcome of the wagering game. For example, the game application 133 can activate a light source and an audio source in response to the outcome being associated with a high-value award, such as a jackpot. The game application 133 can initiate one or more bonus games. The game application 133 can initiate a replay for the wagering game (e.g., thereby providing a second outcome that replaces or modifies that first outcome).

With reference to FIG. 5, shown is a flow chart of a model generation process 500 according to various embodiments of the present disclosure. The gaming service 115, or game application 133, can perform the process 500 to generate and/or train one or more models 126 to generate particular output(s), such as, for example, skill scores 125, skill levels, or one or more modifications to one or more attributes 145.

At box 503, the process 500 includes generating, or retrieving, a first iteration of a model 126. The gaming service 115 can generate or retrieve the model 126 based on one or more factors including, but not limited to, a patron identifier, a previous skill score 125 associated with the patron identifier or a user account 124, a gaming device identifier, or a type of wagering game.

In some embodiments, the gaming service 115 determines whether the model 126 is associated with a time period beyond a predetermined threshold (e.g., 1 hour old, 1 month old, 1 year old, or any suitable interval). In response to the model 126 being associated with a time period beyond the predetermined threshold, the process 500 may proceed to box 506. In response to the model 126 being associated with a time period within the predetermined threshold, the process 500 may proceed to box 524.

At box 506, the process 500 includes generating one or more training datasets. The gaming service 115 can generate the one or more training sets based on gaming data 118A, 118B, or a subset thereof, such as a subset of the gaming data 118A, 118B corresponding to a particular user account 124, patron identifier, type of wagering, particular gaming device 106, or combinations thereof. The training dataset can include, for example, a plurality of outcomes for a plurality of historical wagering games and at least one respective input for each of the plurality of outcomes. The gaming service 115 can process the gaming data 118A, 118B to identify a subset thereof for inclusion in the training dataset. For example, the gaming service 115 determines a subset of the gaming data 118A, 118B associated with one or more near-win outcomes. As another example, the gaming service 1115 determines a subset of the gaming data 118A, 118B associated with a current configuration of attributes 145 of a wagering game. The gaming service 115 may also generate one or more validation sets by dividing the data of the training dataset into a secondary training set and a validation dataset. The gaming service 115 may train the model 126 using the secondary training data set and the validation dataset to optimize the model 126 against overfitting or other model deficiencies.

At box 509, the process 500 includes processing the training dataset via the first iteration of the model 126 to generate one or more outputs. The gaming service 115 can process the training dataset via the model 126 to generate one or more skill scores 125, one or more skill levels, or one or more modifications to one or more attributes 145.

At box 512, the process 500 includes determining the performance of the model 126 based on the output(s) of box 509. The gaming service 115 can determine one or more performance metrics of the model 126 by comparing the output(s) of box 509 to historical wagering game outcomes, historical skill scores, or historical attribute modifications associated with the training dataset. The gaming service 115 can determine, for example, an error of the model 126 by comparing a predicted skill score 125 to a known skill score 125. In another example, the gaming service 115 can determine model error by comparing a predicted effect of an attribute modification to a historical effect of the attribute modification. Further non-limiting examples of performance metrics include accuracy, stability, and precision (e.g., across one or a plurality of training datasets and/or validation datasets). The gaming service 115 can store the current properties and performance of the model 126 at the data store 112.

At box 515, the process 500 includes determining if the performance of the model 126 meets one or more predetermined thresholds. In response to the model 126 meeting the one or more predetermined thresholds, the process 500 can proceed to step 524. In response to the model 126 failing to meet the one or more predetermined thresholds, the process 500 can proceed to step 518. The gaming service 115 can compare the performance of the model 126 to the one or more predetermined thresholds. For example, the gaming service 115 compares an accuracy rate of the model 126 to a predetermined accuracy threshold. In another example, the gaming service 115 compares an error of the model 126 to a predetermined error threshold.

At box 518, the process 500 includes adjusting one or more properties of the model 126 to improve the performance thereof. The gaming service 115 can adjust one or more model properties described herein. For example, the gaming service 115 can adjust one or more parameter weights, activation functions, or layer properties of the model 126 (e.g., depending on the model type). The gaming service 115 can adjust properties of the model 126 via secondary training processes and/or additional models.

At box 521, the process 500 includes generating a second iteration of the model 126 based on the prior iteration of the model 126 and the one or more modified properties of box 518. Following step 521, the process 500 may proceed to step 509. The gaming service 115 can iteratively repeat boxes 509-521 to generate an iteration of the model 126 that demonstrates sufficient performance (e.g., satisfying the one or more predetermined thresholds of box 515).

At box 524, the process 500 includes generating a skill score 125 by processing gaming data 118A, 118B via the threshold(s)-satisfying iteration of the model 126. The gaming service 115 can process, via the model 126, gaming data 118A, 118B corresponding to a patron identifier to generate a skill score 125 for a user account 124 with which the patron identifier is associated. The gaming service 115 can generate a plurality of skill scores 125 and compute a weighted or unweighted average of the skill scores 125 for use as the skill score 125 from which modifications to attributes 145 may be determined.

At box 527, the process 500 includes generating one or more modifications to attributes 145 based on the skill score 125 and via the model 126 of boxes 509-521, or another model 126. In some embodiments, following box 524, the process 500 proceeds to step 530. The gaming service 115 can simulate one or more modifications to one or more attributes 145, thereby generating modified gaming data 118A, 118B. The gaming service 115 can process, via the model 126, the modified gaming data 118A, 118B. The gaming service 115 can compare the output of the model (e.g., a skill score or skill level) to the output of box 524. The gaming service 115 can iteratively simulate and evaluate modifications to one or more attributes 145 to determine one or more modifications that result in a predicted outcome of wagering game meeting a predetermined outcome, such as an outcome associated with an average or other desired level of performance. In other words, the gaming service 115 can identify attribute modifications that, when present in a wagering game, increase performance of a low skill patron to that of an average skill patron or regress performance of a high skill patron to that of an average skill patron.

At box 530, the process 500 includes performing one or more appropriate actions. The gaming service 115 can store the skill score 125 of box 524 in association with a patron identifier and/or user account 124. The gaming service 115 can transmit the skill score 125 and/or modifications to one or more attributes 145 to the game application 133. The gaming service 115 can store the threshold-satisfying iteration of the model 126 (e.g., and, in some embodiments, training datasets associated therewith) at the data store 112.

Turning to FIG. 6, shown is an exemplary gaming device 106. The gaming device 106 can include one or more display devices 108A, 108B. The gaming device 106 can render, on the display device 108, a title of the type wagering game provided thereby. The gaming device 106 can render, on the display device 108, a maximum award achievable via the wagering game, such as a jackpot amount.

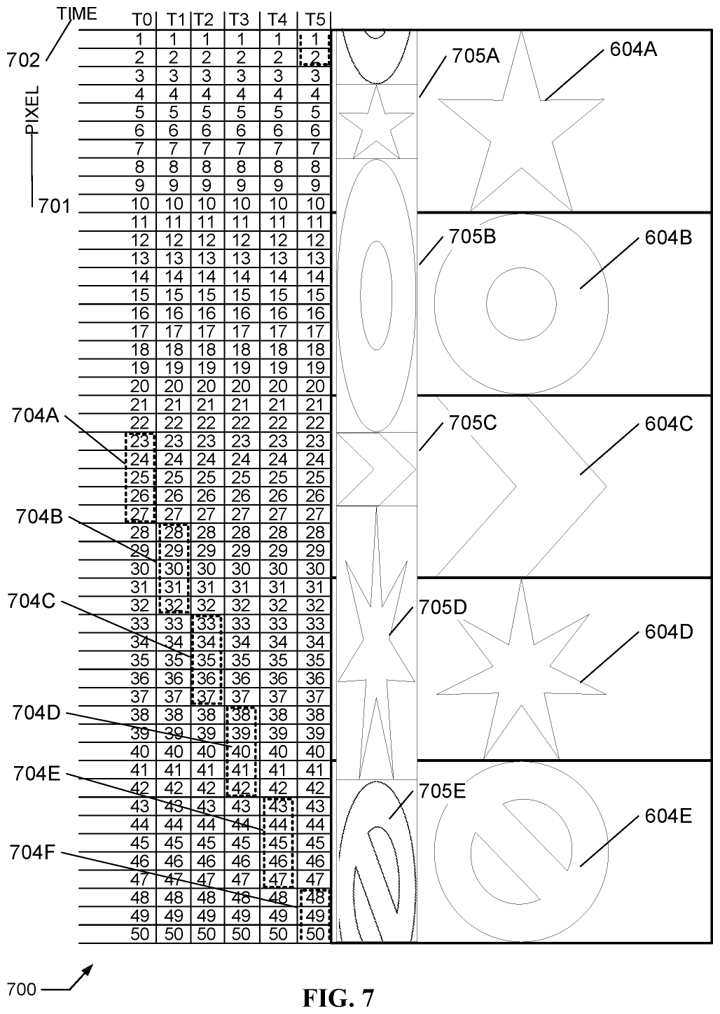

The gaming device 106 can render, on the display device 108B, a game interface 601. The game interface 601 can include, but is not limited to, reels 605A, 605B, 605C, one or more alignment indicators 603, and indicia 604A, 604B, 604C, 604D, 604E. The gaming device 106 can render the game interface based on a reel schema, such as any of the reel schemas 700, 800, 900 shown in FIGS. 7, 8, and 9, respectively, and described herein. The gaming device 106 can render, on the display device 108B, outcomes 602. The outcomes 602 can illustrate winning combinations of the indicia 604A-E (e.g., and, in some embodiments, awards associated with each winning combination). The gaming device 106 can include input devices 110A, 110B for receiving inputs from a patron, such as inputs for controlling wagering games or providing patron data (e.g., a ticket, badge, or patron identifier). As shown in the figures and described herein, the gaming service 115, or game application 133, can modify various attributes 145 of wagering games at the gaming device 106, including modifying the input devices 110A, 110B or effect sources (not shown).

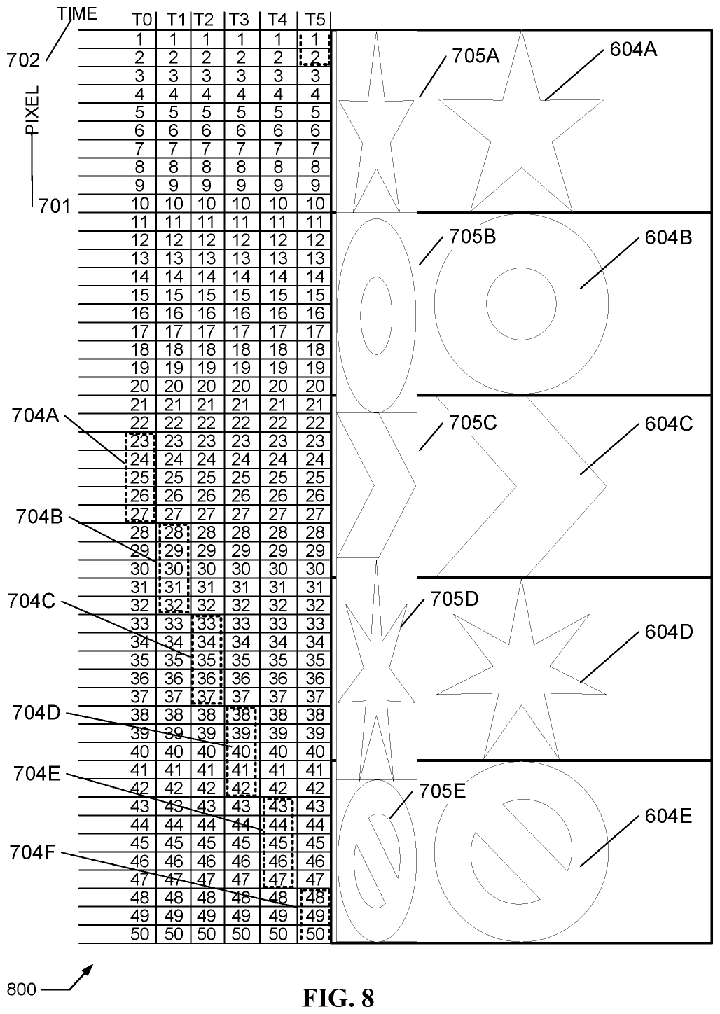

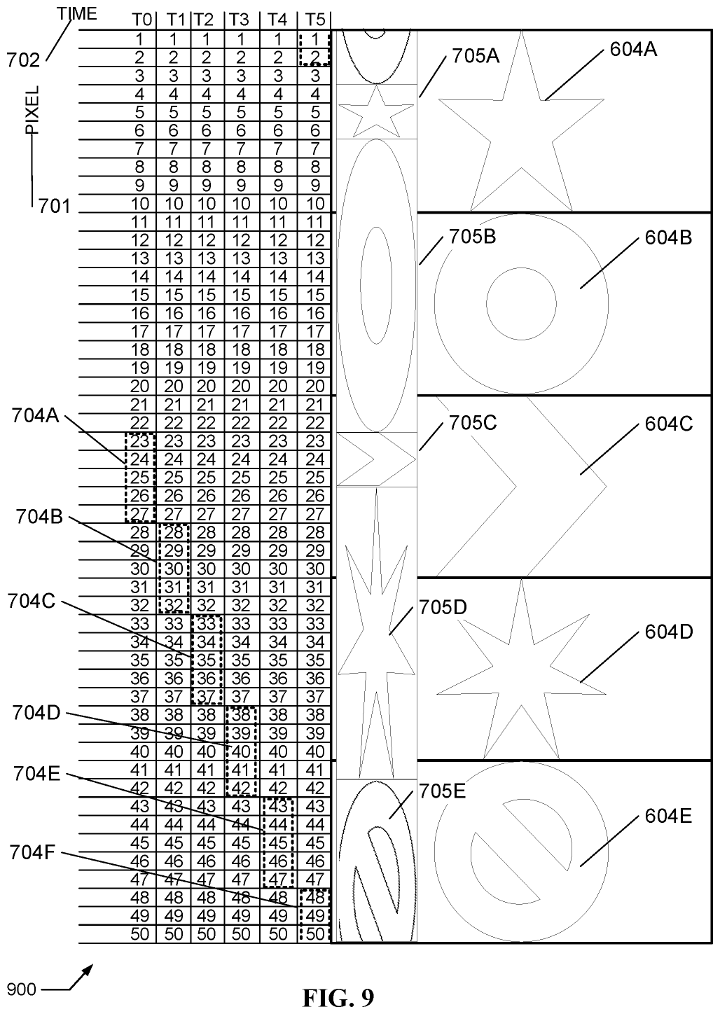

Turning to FIGS. 7-9, shown are exemplary reel schemas 700 (FIG. 7), 800 (FIG. 8), and 900 (FIG. 9) that may be generated and implemented by the gaming system 103 to determine the outcomes of wagering games described herein. For purposes of illustration and description, the reel schemas 700, 800, 900 are presented in the context of a display region comprising a 50-pixel height. It will be understood that the reel schemas shown and described herein may be scaled and reconfigured for any suitable display size, such as 720p, 1080p, 4k, etc., and any orientation (e.g., vertically oriented, horizontally oriented, or any suitable display angle). The reels schemas 700, 800, 900 demonstrate modifications to attributes 145 that may be performed to configure the difficulty of wagering game for an average skill patron (FIG. 7), a low skill patron (FIG. 8), or a high skill patron (FIG. 9).

Turning to FIG. 7, the reel schema 700 can include a plurality of indicia 604A-E, a plurality of hitboxes 705A-E individually corresponding to a respective one of the plurality of indicia 604A-E, a selection object 704A-F, a pixel position dimension 701, and a time dimension 702. The pixel dimension 701 illustrates the pixel position of the selection object 704A-F as a function of the time dimension 702.

The dimensions (e.g., pixel height, pixel width, etc.) of each hitbox 704A-F may be configured to increase or decrease the probability of a collision between the corresponding hitbox 705A-E and the selection object 705A-E. For example, hitbox 705A can be configured to pixel height of four pixels, hitbox 705B to a pixel height of fifteen pixels, hitbox 705C to a pixel height of four pixels, hitbox 705D to a pixel height of fifteen pixels, and hitbox 705E to a pixel height of twelve pixels. Thus, for a given wagering game, the selection object 70A-E may demonstrate a greatest probability of colliding with hitboxes 705B, 705D and a lowest probability of colliding with hitboxes 705A, 705C. In other words, a patron may experience greater difficulty in timing an input to stop wagering game when the selection object 704A-F is in collision with hitboxes 705A, 705C as compared to hitbox 705E and, in particular, hitboxes 705B, 705D. As further shown in the reel schema 800 (FIG. 8) and reel schema 900 (FIG. 9), the gaming system can adjust the dimensions of the hitboxes 705A-E to adjust the probability of hitbox collisions and, thus, the difficulty of the wagering game.

The gaming system 103 can adjust the dimensions of the selection object 704A-F. The gaming system 103 can adjust the height and/or width of the selection object 704A-F to effect changes in wagering game outcome probabilities and, thereby, wagering game difficulty. For example, the gaming system 103 can adjust the selection object 704A-F from a pixel height of five pixels to a pixel height of one pixel (e.g., to increase difficulty) or a pixel height of ten pixels (e.g., to potentially reduce difficulty, depending on comparative dimensions of hitboxes). The gaming system 103 can adjust the dimension(s) of the selection object 704A-F, or hitboxes 704A-F, as a function of the pixel dimension 701, the time dimension 703, or a combination thereof. For example, at times T0-T3, the gaming system 103 can configure selection boxes 703A-D to a pixel height of five pixels, and at times T4-T5, configure selection boxes 703E, F to a pixel height of one pixel. The gaming system 103 can configure an availability period for the selection object 704A-F such that, at varying points in the pixel dimension 701 and/or time dimension 702, inputs for stopping the movement of the selection object 704A-F and evaluating hitbox collision are executed or ignored.

Turning to FIG. 8, the reel schema 800 demonstrates an embodiment of a wagering game in which the gaming system 103 adjusts wagering game outcome probabilities by increasing the dimension(s) of the hitboxes 705A, 705C, and decreasing dimension(s) of hitboxes 705B, 705D, 705E. Compared to reel schemas 700 and 800, the reel schema 800 may decrease the difficulty for a patron to provide an input such that the wagering game is stopped while the selection object 704A-F is in collision with the hitboxes 705A, 705C.

Turning to FIG. 9, the reel schema 900 demonstrates an embodiment of a wagering game in which the gaming system 103 adjusts wagering game outcome probabilities by decreasing the dimension(s) of the hitboxes 705A, 705C, and increasing dimension(s) of the hitboxes 705B, 705D, 705E. Compared to reel schemas 700 and 800, the reel schema 800 may increase the difficulty for a patron to provide an input such that the wagering game is stopped while the selection object 704A-F is in collision with the hitboxes 705A, 705C. The gaming system 103 can implement any suitable reel schema to modify wagering game attributes based on patron skill (e.g., as measured via skill score or skill level). While not shown in FIGS. 7-9, the gaming system 103 can modify other reel schema properties to effect changes to wagering game attributes (e.g., and, thereby, increase, maintain, or decrease wagering game difficulty respective to a patron's predicted skill). Additional non-limiting examples of reel schema properties include selection object dimension(s), selection box availability, selection box movement pattern (e.g., sequential, random, non-sequential alternating between hitbox positions, etc.), and hitbox availability.

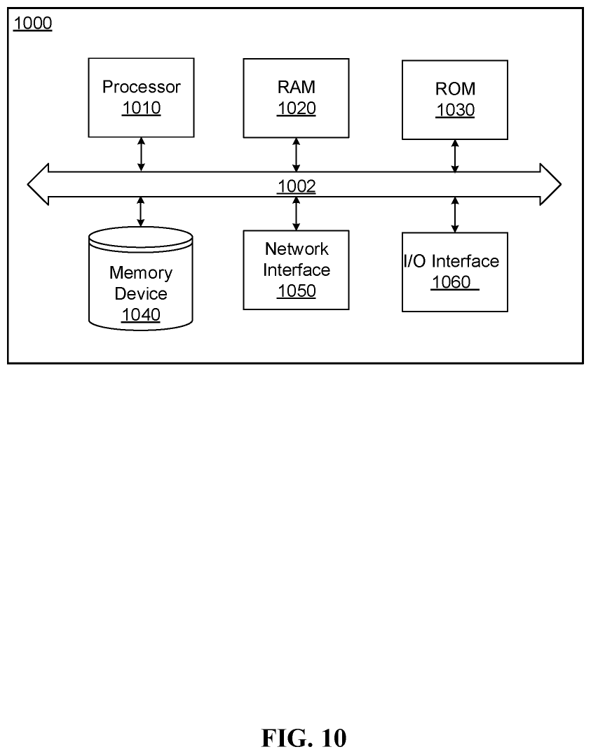

Turning to FIG. 10, an example hardware diagram of a computing device 600 is illustrated. Any of the gaming system 103 or the gaming devices 106 may be implemented, in part, using one or more elements of the computing device 1000. The computing device 1000 can include one or more of a processor 1010, a Random Access Memory (“RAM”) 1020, a Read Only Memory (“ROM”) 1030, a memory device 1040, a network interface 1050, and an Input Output (“I/O”) interface 1060. The elements of the computing device 1000 are communicatively coupled via a bus 1002.

The processor 1010 can include an arithmetic processor, Application Specific Integrated Circuit (“ASIC”), or other types of hardware or software processors. The RAM 1020 and ROM 1030 can include a memory that stores computer-readable instructions to be executed by the processor 1010. The memory device 1040 stores computer-readable instructions thereon that, when executed by the processor 1010, direct the processor 1010 to execute various aspects of the present disclosure described herein. When the processor 1010 includes an ASIC, the processes described herein may be executed by the ASIC according to an embedded circuitry design of the ASIC, by firmware of the ASIC, or both an embedded circuitry design and firmware of the ASIC. As a non-limiting example group, the memory device 1040 comprises one or more of an optical disc, a magnetic disc, a semiconductor memory (i.e., a semiconductor, floating gate, or similar flash based memory), a magnetic tape memory, a removable memory, combinations thereof, or any other known memory means for storing computer-readable instructions. The network interface 1050 can include hardware interfaces to communicate over data networks. The I/O interface 1060 can include device input and output interfaces such as keyboard, pointing device, display, communication, and other interfaces. The bus 1002 can electrically and communicatively couple the processor 1010, the RAM 1020, the ROM 1030, the memory device 1040, the network interface 1050, and the I/O interface 1060, so that data and instructions may be communicated among them.

In operation, the processor 1010 is configured to retrieve computer-readable instructions stored on the memory device 1040, the RAM 1020, the ROM 1030, or another storage means and copy the computer-readable instructions to the RAM 1020 or the ROM 1030 for execution, for example. The processor 1010 is further configured to execute the computer-readable instructions to implement various aspects and features of the present disclosure. For example, the processor 1010 may be adapted and configured to execute the processes described above with reference to FIGS. 3-5, including the processes described as being performed by the gaming system 103 or gaming devices 106. Also, the memory device 1040 may store the data stored in the data store 112 or 130.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LAN (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

Clause 1. A system, comprising: a display device; and at least one computing device, one or more of the at least one computing device is in communication with the display device and the at least one computing device is configured to: determine gaming data comprising a plurality of outcomes for a plurality of historical wagering games associated with a particular user account; determine a skill score corresponding to the particular user account based on the gaming data; render, on the display device, a reel comprising a subset of a plurality of indicia; modify at least one attribute of a wagering game based on the skill score; rotate the subset of the plurality of indicia on the reel on the display device; receive an input from a user; stop rotation of the reel at a particular position based on the input and a current value of the at least one attribute; and determine an outcome of the wagering game based on a stopped position of the reel.

Clause 2. The system of clause 1 or any other clause herein, wherein determining the skill score comprises the at least one computing device being further configured to process the gaming data via at least one machine learning model.

Clause 3. The system of clause 2 or any other clause herein, wherein the at least one computing device is further configured to: generate a training dataset based on the gaming data, the gaming data comprising: the plurality of outcomes for the plurality of historical wagering games; and at least one respective input for each of the plurality of outcomes; and train the at least one machine learning model using the training dataset.

Clause 4. The system of clause 1 or any other clause herein, wherein the reel comprises a plurality of hitboxes individually corresponding to a respective one of the subset of the plurality of indicia.

Clause 5. The system of clause 4 or any other clause herein, wherein at least one computing device is further configured to: determine a collision of a selection object with a particular hitbox of the plurality of hitboxes based on a current position of the reel when the input is received from the user; and in response to the collision, stop rotation of the reel at the particular position corresponding to a particular indicia corresponding to the particular hitbox.

Clause 6. The system of clause 5 or any other clause herein, wherein the at least one attribute comprises at least one dimension of at least one hitbox of the plurality of hitboxes.

Clause 7. The system of clause 6 or any other clause herein, wherein the at least one dimension is hitbox pixel height.

Clause 8. The system of clause 6 or any other clause herein, wherein the at least one dimension is hitbox pixel width.

Clause 9. A method, comprising: determining, via at least one computing device, gaming data comprising a plurality of outcomes for a plurality of historical wagering games associated with a particular user account; determining, via the at least one computing device, a skill score corresponding to the particular user account based on the gaming data; rendering, via the at least one computing device, a reel comprising a subset of a plurality of indicia on a display device; modifying, via the at least one computing device, at least one attribute of a wagering game based on the skill score; rotating, via the at least one computing device, the reel on the display device; receiving, via at least one input device coupled to the at least one computing device, an input from a user; stopping, via the at least one computing device, rotation of the reel at a particular position based on the input and a current value of the at least one attribute; and determining, via the at least one computing device, an outcome of a wagering game based on a stopped position of the reel.

Clause 10. The method of clause 9 or any other clause herein, wherein the at least one attribute comprises a rotation speed of the reel on the display device.

Clause 11. The method of clause 9 or any other clause herein, wherein the at least one attribute comprises a rotation direction of the reel on the display device.

Clause 12. The method of clause 9 or any other clause herein, wherein the at least one attribute comprises a rotation acceleration of the reel on the display device.

Clause 13. The method of clause 9 or any other clause herein, wherein the at least one attribute comprises a latency period between receiving the input from the user and stopping the rotation of the reel.

Clause 14. The method of clause 9 or any other clause herein, wherein the at least one attribute comprises a rendering of a second reel on the display device.

Clause 15. The method of clause 9 or any other clause herein, wherein: the input from the user is a first user input; the method further comprises: rendering, via the at least one computing device, a second reel comprising a second subset of the plurality of indicia on the display device; rotating, via the at least one computing device, the second reel on the display device; stopping, via the at least one computing device, rotation of the second reel at a second particular position based on a second user input; and determining, via the at least one computing device, the outcome of the wagering game based on the stopped position of the reel and a stopped position of the second reel; and the at least one attribute comprises a ratio between a rotation speed of the reel and a rotation speed of the second reel rendered on the display device.

Clause 16. A non-transitory, computer-readable medium embodying a program that, when executed by at least one computing device, causes the at least one computing device to: determine gaming data comprising a plurality of outcomes for a plurality of historical wagering games associated with a particular user account; determine a skill score corresponding to the particular user account based on the gaming data; render, on a display device, a reel comprising a subset of a plurality of indicia; modify at least one attribute of at least one of the subset of a wagering game based on the skill score; rotate the subset of the plurality of indicia on the reel on the display device; receive an input from a user via a first input device; stop rotation of the reel at a particular position based on the input and a current value of the at least one attribute; and determine an outcome of the wagering game based on a stopped position of the reel.

Clause 17. The non-transitory, computer-readable medium of clause 16 or any other clause herein, wherein the at least one attribute is at least one setting of an effect source and the program, when executed by the at least one computing device, causes the at least one computing device to activate the effect source based on the at least one setting.

Clause 18. The non-transitory, computer-readable medium of clause 17 or any other clause herein, wherein the at least one setting comprises a frequency of activation.

Clause 19. The non-transitory, computer-readable medium of clause 17 or any other clause herein, wherein the at least one setting comprises activation intensity.

Clause 20. The non-transitory, computer-readable medium device of clause 16 or any other clause herein, wherein the at least one attribute is for at least one of the subset of the plurality of indicia.

These and other clauses, aspects, features, and benefits of the claimed invention(s) will become apparent from the above detailed written description of the preferred embodiments and aspects taken in conjunction with the drawings included herewith, although variations and modifications thereto may be effected without departing from the spirit and scope of the novel concepts of the disclosure.

Therefore, at least the following is claimed:

1. A system, comprising:
a display device; and
at least one computing device, one or more of the at least one computing device is in communication with the display device and the at least one computing device is configured to:
determine gaming data comprising a plurality of outcomes for a plurality of historical wagering games associated with a particular user account;
determine a skill score corresponding to the particular user account based on the gaming data;
render, on the display device, a reel comprising a subset of a plurality of indicia;
modify at least one attribute of a wagering game based on the skill score;
rotate the subset of the plurality of indicia on the reel on the display device;
receive an input from a user;
stop rotation of the reel at a particular position based on the input and a current value of the at least one attribute; and
determine an outcome of the wagering game based on a stopped position of the reel.

2. The system of claim 1, wherein determining the skill score comprises the at least one computing device being further configured to process the gaming data via at least one machine learning model.

3. The system of claim 2, wherein the at least one computing device is further configured to:
generate a training dataset based on the gaming data, the gaming data comprising:
the plurality of outcomes for the plurality of historical wagering games; and
at least one respective input for each of the plurality of outcomes; and
train the at least one machine learning model using the training dataset.

4. The system of claim 1, wherein the reel comprises a plurality of hitboxes individually corresponding to a respective one of the subset of the plurality of indicia.

5. The system of claim 4, wherein at least one computing device is further configured to:
determine a collision of a selection object with a particular hitbox of the plurality of hitboxes based on a current position of the reel when the input is received from the user; and
in response to the collision, stop rotation of the reel at the particular position corresponding to a particular indicia corresponding to the particular hitbox.

6. The system of claim 5, wherein the at least one attribute comprises at least one dimension of at least one hitbox of the plurality of hitboxes.

7. The system of claim 6, wherein the at least one dimension is hitbox pixel height.

8. The system of claim 6, wherein the at least one dimension is hitbox pixel width.

9. A method, comprising:
determining, via at least one computing device, gaming data comprising a plurality of outcomes for a plurality of historical wagering games associated with a particular user account;
determining, via the at least one computing device, a skill score corresponding to the particular user account based on the gaming data;
rendering, via the at least one computing device, a reel comprising a subset of a plurality of indicia on a display device;
modifying, via the at least one computing device, at least one attribute of a wagering game based on the skill score;
rotating, via the at least one computing device, the reel on the display device;
receiving, via at least one input device coupled to the at least one computing device, an input from a user;
stopping, via the at least one computing device, rotation of the reel at a particular position based on the input and a current value of the at least one attribute; and
determining, via the at least one computing device, an outcome of a wagering game based on a stopped position of the reel.

10. The method of claim 9, wherein the at least one attribute comprises a rotation speed of the reel on the display device.

11. The method of claim 9, wherein the at least one attribute comprises a rotation direction of the reel on the display device.

12. The method of claim 9, wherein the at least one attribute comprises a rotation acceleration of the reel on the display device.

13. The method of claim 9, wherein the at least one attribute comprises a latency period between receiving the input from the user and stopping the rotation of the reel.

14. The method of claim 9, wherein the at least one attribute comprises a rendering of a second reel on the display device.

15. The method of claim 9, wherein:
the input from the user is a first user input;
the method further comprises:
rendering, via the at least one computing device, a second reel comprising a second subset of the plurality of indicia on the display device;
rotating, via the at least one computing device, the second reel on the display device;
stopping, via the at least one computing device, rotation of the second reel at a second particular position based on a second user input; and
determining, via the at least one computing device, the outcome of the wagering game based on the stopped position of the reel and a stopped position of the second reel; and
the at least one attribute comprises a ratio between a rotation speed of the reel and a rotation speed of the second reel rendered on the display device.

16. A non-transitory, computer-readable medium embodying a program that, when executed by at least one computing device, causes the at least one computing device to:
determine gaming data comprising a plurality of outcomes for a plurality of historical wagering games associated with a particular user account;
determine a skill score corresponding to the particular user account based on the gaming data;
render, on a display device, a reel comprising a subset of a plurality of indicia;
modify at least one attribute of at least one of the subset of a wagering game based on the skill score;
rotate the subset of the plurality of indicia on the reel on the display device;
receive an input from a user via a first input device;
stop rotation of the reel at a particular position based on the input and a current value of the at least one attribute; and
determine an outcome of the wagering game based on a stopped position of the reel.

17. The non-transitory, computer-readable medium of claim 16, wherein the at least one attribute is at least one setting of an effect source and the program, when executed by the at least one computing device, causes the at least one computing device to activate the effect source based on the at least one setting.

18. The non-transitory, computer-readable medium of claim 17, wherein the at least one setting comprises a frequency of activation.

19. The non-transitory, computer-readable medium of claim 17, wherein the at least one setting comprises activation intensity.

20. The non-transitory, computer-readable medium device of claim 16, wherein the at least one attribute is for at least one of the subset of the plurality of indicia.
